(19) United States
(12) Patent Application Publication
(10) Pub. No.: US 2026/0117338 A1
(43) Pub. Date: Apr. 30, 2026

(54) NON-ORIENTED ELECTRICAL STEEL SHEET, ROTOR CORE, MOTOR, AND METHOD FOR PRODUCING NON-ORIENTED ELECTRICAL STEEL SHEET

(71) Applicant: NIPPON STEEL CORPORATION, Tokyo (JP)

(72) Inventors: Yoshiaki NATORI, Chiyoda-ku, Tokyo (JP); Minako FUKUCHI, Chiyoda-ku, Tokyo (JP); Hiroyoshi YASHIKI, Chiyoda-ku, Tokyo (JP)

(73) Assignee: NIPPON STEEL CORPORATION, Tokyo (JP)

(21) Appl. No.: 19/472,750

(22) PCT Filed: Apr. 5, 2024
(86) PCT No.: PCT/JP2024/014046

§ 371 Date: Oct. 6, 2025

(30) Foreign Application Priority Data
Apr. 7, 2023 (JP) 2023-062516

(51) Int. Cl. C21D 9/46; C21D 8/1216; C21D 8/1244; C22C 38/02

(52) U.S. Cl. CPC C21D 9/46; C21D 8/1222; C21D 8/1233; C21D 8/1272; C22C 38/02

(57) ABSTRACT

A non-oriented electrical steel sheet of this embodiment contains, in mass %, Si: 3.1 to 4.5%, and in addition, Ti, Si, Al, Zr, Nb, V, Mo, Cr, C, La, Ce, and N satisfy Formula (1) and Formula (2), a tensile strength TS is higher than 570 MPa, a work hardening amount WH defined by Formula (3) is less than 15 MPa, an average grain size D (m) satisfies Formula (4), and a yield elongation is 0.5% or more.

$$Si / 28 + Ti / 48 + Nb / 93 + V / 51 + Zr / 91 + Mo / 96 + Cr / 52 > C / 12 \times 750 \qquad ( 1 )$$

$$Si / 28 + Al / 27 + Ti / 48 + Zr / 91 + La / 139 + Ce / 140 > N / 14 \times 1000 \qquad ( 2 )$$

$$WH = {Y}_{2.} - YS \qquad ( 3 )$$

$$D < 80 - Si \times 10 \qquad ( 4 )$$

### TECHNICAL FIELD

The present disclosure relates to a non-oriented electrical steel sheet, a rotor core, a motor, and a method for producing a non-oriented electrical steel sheet.

### BACKGROUND ART

Non-oriented electrical steel sheets are widely utilized as a starting material for motor cores (iron cores). In order to obtain a high-efficiency motor core, a non-oriented electrical steel sheet is required to have excellent iron loss. Therefore, in order to produce non-oriented electrical steel sheets with excellent iron loss, steel sheets that have higher degrees of alloying are being increasingly produced.

A motor core includes a stator core that serves as a stator, and a rotor core that serves as a rotor. Among the stator core and the rotor core, for the following reasons, the rotor core in particular is required to have both high strength and excellent magnetic properties (reduced iron loss deterioration). In recent years, motors for use in electric vehicles and hybrid vehicles are being designed to increase motor output by increasing the motor rotation speed. Therefore, the loads applied to the rotor cores, which are rotors, during operation of the motors are increasing. Therefore, the rotor cores are required to have high strength. Further, because the rotor core is fixed to a rotary shaft, the rotor core is difficult to cool. Therefore, thermal management of the rotor core is also important. The iron loss of a non-oriented electrical steel sheet ultimately becomes heat. Therefore, from the viewpoint of thermal management of the rotor core also, there is a need to reduce the iron loss deterioration of non-oriented electrical steel sheets.

A non-oriented electrical steel sheet that has high strength and excellent magnetic properties is proposed in Japanese Patent Application Publication No. 2008-050686 (Patent Literature 1). According to Patent Literature 1, high strength and excellent magnetic properties are realized by appropriately adjusting the chemical composition.

### CITATION LIST

### Patent Literature

Patent Literature 1: Japanese Patent Application Publication No. 2008-050686

### SUMMARY OF INVENTION

### Technical Problem

In this connection, when producing a rotor core from a non-oriented electrical steel sheet, the non-oriented electrical steel sheet is subjected to blanking to produce a blanked product such as a rotor core starting material. When using a high alloy and high strength non-oriented electrical steel sheet, it may be difficult to cut out the steel sheet into a desired shape during blanking, and in some cases the dimensional accuracy of the blanked product obtained after blanking may decrease. Specifically, unevenness may occur on an end face of a blanked product (blanked end face) after blanking. If unevenness occurs on a blanked end face, when the blanked product is assembled into a motor, it will be difficult for the blanked product to closely contact other parts such as a magnet, a shaft, or a motor case at the contact interfaces with the other parts. Consequently, a problem will arise in fixing the motor core. In addition, a problem with heat dissipation will also arise with respect to the aforementioned thermal management of the motor core. On the other hand, shear strain introduced into a non-oriented electrical steel sheet causes a deterioration in iron loss. Therefore, the amount of heat generation of the motor core increases. Recently, rotor core starting materials are increasingly being blanked into complex shapes to improve their functionality. Therefore, the proportion of a blanked end face in rotor core starting materials has been increasing. As a result, reducing iron loss deterioration that is caused by shear strain introduced into a rotor core starting material during blanking is also becoming increasingly important.

An objective of the present disclosure is to provide a non-oriented electrical steel sheet in which high strength and excellent magnetic properties are obtained and which is excellent in dimensional accuracy after blanking, as well as a rotor core, a motor, and a method for producing the non-oriented electrical steel sheet.

### Solution to Problem

A non-oriented electrical steel sheet of the present disclosure consists of, in mass %, Si: 3.1 to 4.5%, C: 0.0025% or less, N: 0.0025% or less, O: 0.0400% or less, P: 0.100% or less, S: 0.0050% or less, Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, Ce: 0 to 0.0100%, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%, with the balance being Fe and impurities, and satisfies Formula (1) and Formula (2):

$$Si / 28 + Ti / 48 + Nb / 93 + V / 51 + Zr / 91 + Mo / 96 + Cr / 52 > C / 12 \times 750 \qquad ( 1 )$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

In the non-oriented electrical steel sheet, in addition, a tensile strength TS is higher than 570 MPa.

In the non-oriented electrical steel sheet, furthermore, when a stress at 2.0% strain is expressed as Y_{2.0} (MPa) and a yield stress is expressed as YS (MPa), a work hardening amount WH defined by Formula (3) is less than 15 MPa.

$$WH = {Y}_{2.} - YS \qquad ( 3 )$$

In the non-oriented electrical steel sheet, in addition, an average grain size D (μm) satisfies Formula (4), and a yield elongation is 0.5% or more:

$$D < 80 - Si \times 10 \qquad ( 4 )$$

where, a content of a corresponding element in percent by mass is substituted for a symbol of an element in Formula (4), and if the corresponding element is not contained, “0” is substituted for the symbol of the corresponding element.

A rotor core of the present disclosure includes a plurality of rotor core starting materials stacked together.

The rotor core starting material consists of, in mass %, Si: 3.1 to 4.5%, C: 0.0025% or less, N: 0.0025% or less, O: 0.0400% or less, P: 0.100% or less, S: 0.0050% or less, Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, Ce: 0 to 0.0100%, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%, with the balance being Fe and impurities, and satisfies Formula (1) and Formula (2):

$$Si / 28 + Ti / 48 + Nb / 93 + V / 51 + Zr / 91 + Mo / 96 + Cr / 52 > C / 12 \times 750 \qquad ( 1 )$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

In the rotor core starting material, in addition, a tensile strength TS is higher than 570 MPa.

In the rotor core starting material, furthermore, when a stress at 2.0% strain is expressed as Y_{2.0} (MPa) and a yield stress is expressed as YS (MPa), a work hardening amount WH defined by Formula (3) is less than 15 MPa.

$$WH = {Y}_{2.} - YS \qquad ( 3 )$$

In the rotor core starting material, in addition, an average grain size D (° m) satisfies Formula (4), and a yield elongation is 0.5% or more:

$$D < 80 - Si \times 10 \qquad ( 4 )$$

where, a content of a corresponding element in percent by mass is substituted for a symbol of an element in Formula (4), and if the corresponding element is not contained, “0” is substituted for the symbol of the corresponding element.

A motor of the present disclosure includes the rotor core described above.

A method for producing a non-oriented electrical steel sheet of the present disclosure includes a hot rolling process, a cold rolling process, and a final annealing process.

In the hot rolling process, a slab is subjected to hot rolling to produce a hot-rolled steel sheet.

In the cold rolling process, the hot-rolled steel sheet is subjected to cold rolling to produce a cold-rolled steel sheet.

In the final annealing process, the cold-rolled steel sheet is subjected to final annealing in a final annealing furnace.

In the final annealing process, in addition, the cold-rolled steel sheet is annealed at a maximum attainment temperature T1 of 950° C. or less. Further, a tension TE applied to the cold-rolled steel sheet at the maximum attainment temperature T1 is set to 2.0 to 10.0 MPa. In addition, a residence time t0 (seconds) from an annealing temperature T1 to 700° C. in a heating zone, a soaking zone, and a cooling zone of the final annealing furnace, and a residence time t1 (seconds) from 700 to 500° C. in the cooling zone are set to satisfy Formula (A) and Formula (B).

$$t 1 - t 0 > 0 \qquad ( A )$$

$$t 1 / t 0 \leq 3. \qquad ( B )$$

In addition, at one location or more selected from the heating zone, the soaking zone, and the cooling zone in a temperature range of 500° C. or more in a furnace atmosphere of the final annealing furnace, a ratio of a water vapor partial pressure P_{H20} (atm) to a hydrogen partial pressure P_{H2} (atm) is made higher than 0.05, or an oxygen concentration is made higher than 0.010%.

Further, a temperature gradient CG in a longitudinal direction of the cold-rolled steel sheet in a cooling process is made 20° C./m or less.

### Advantageous Effects of Invention

In the non-oriented electrical steel sheet of the present disclosure, high strength and excellent magnetic properties are obtained, and the non-oriented electrical steel sheet is excellent in dimensional accuracy after blanking. The rotor core of the present disclosure and the motor of the present disclosure are produced using the non-oriented electrical steel sheet of the present disclosure as a starting material. The method for producing a non-oriented electrical steel sheet of the present disclosure can produce the aforementioned non-oriented electrical steel sheet of the present disclosure.

### BRIEF DESCRIPTION OF DRAWINGS

FIG. 1 is a schematic diagram showing an example of a stress-strain curve.

FIG. 2 is a schematic diagram showing an example of a stress-strain curve that is different from FIG. 1.

FIG. 3 is a schematic diagram for describing a method for determining the yield elongation in a case where the upper yield point is not clear in a stress-strain curve.

FIG. 4 is a plan view illustrating an example of a rotor core of the present embodiment.

FIG. 5 is a plan view illustrating an example of a stator core of the present embodiment.

FIG. 6 is a schematic diagram for describing a definition of blanking flatness in a dimensional accuracy evaluation test after blanking in the examples.

### DESCRIPTION OF EMBODIMENTS

The present inventors carried out studies and investigations regarding the cause of a decrease in the dimensional accuracy and the cause of a deterioration in the magnetic properties of a blanked product (a rotor core starting material or the like) when a non-oriented electrical steel sheet that has high strength and excellent magnetic properties is blanked. As a result, the present inventors obtained the following findings.

During blanking, when a non-oriented electrical steel sheet is pushed into a die by a blanking punch, in the steel sheet, a portion which is near the steel sheet surface to be pushed in by the punch is pushed into the die in the thickness direction and processed. On the other hand, in the steel sheet, the portion which is in contact with the die is pulled to the chip side. Thus, the direction of stress which is applied to a steel sheet during blanking changes in a complex manner. Therefore, after the steel sheet is fractured during blanking, the degree of springback when the stress is released differs in the thickness direction of the steel sheet. As a result, unevenness occurs on the end face (blanked end face) of the blanked product, and the dimensional accuracy of the blanked product decreases. Such a decrease in dimensional accuracy is particularly noticeable in a case where the tensile strength of the steel sheet is higher than 570 MPa.

When a steel sheet is deformed by blanking, a plurality of dislocations are introduced into the steel sheet. When the dislocations introduced by deformation entangle with each other and work hardening progresses, the amount of springback that occurs when stress is released after the steel sheet is fractured during blanking increases further. As a result, unevenness occurs on the end face of the blanked product (blanked end face) after blanking, and the dimensional accuracy of the blanked product decreases.

Furthermore, in a non-oriented electrical steel sheet, dislocations are introduced by shear strain that is applied during blanking. Magnetic properties deteriorate due to the introduced dislocations. Progression of work hardening means, in other words, that dislocations entangle with each other and remain in the steel sheet. Therefore, the iron loss of the steel sheet deteriorates further as the work hardening progresses.

In consideration of the above mechanism, the present inventors have considered that if the work hardening amount could be reduced, the dimensional accuracy of a blanked product after blanking would improve and, in addition, iron loss deterioration could be suppressed. As a result of further studies, the present inventors have found that if a work hardening amount WH defined by Formula (3) is made less than 15 MPa, excellent dimensional accuracy and excellent magnetic properties will be obtained after blanking.

$$WH = {Y}_{2.} - YS \qquad ( 3 )$$

The present inventors also investigated means for making the work hardening amount WH less than 15 MPa. As a result, the present inventors obtained the following finding.

Silicon (Si) restricts slip systems along which dislocations can move. If the content of Si in a steel sheet is increased, slip systems along which dislocations can move will be restricted. Therefore, entanglement of dislocations due to the occurrence of cross-slips will be suppressed. As a result, an increase in dislocation density will be suppressed.

In addition, dissolved C and dissolved N in a steel sheet tend to fix to dislocations. It is difficult for dislocations to which dissolved C or dissolved N is fixed to move. Therefore, dislocations to which dissolved C or dissolved N is fixed are likely to become entangled with dislocations that are moving. As a result, variations arise in the dislocation density in the steel sheet. In order to decrease the number of such dislocations to which dissolved C or dissolved N is fixed, it is effective to reduce dissolved C and dissolved N in the steel sheet.

To reduce dissolved C and dissolved N in a steel sheet, it suffices to contain elements with high affinity to C and/or N in the steel sheet to thereby fix C and N as precipitates. Si, Ti, and Zr have high affinity to C and N. Nb, V, Mo, and Cr have high affinity to C. Further, Al, La, and Ce have high affinity to N. Therefore, if any one or more types of these element groups are contained, dissolved C and dissolved N in the steel sheet can be reduced.

The present inventors conducted studies from the viewpoint of the chemical composition on the basis of the considerations described above. As a result, the present inventors have considered that if a non-oriented electrical steel sheet has a chemical composition that consists of, in mass %, Si: 3.1 to 4.5%, C: 0.0025% or less, N: 0.0025% or less, O: 0.0400% or less, P: 0.100% or less, S: 0.0050% or less, Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, Ce: 0 to 0.0100%, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%, with the balance being Fe and impurities, and also satisfies Formula (1) and Formula (2), excellent magnetic properties will be obtained and the dimensional accuracy after blanking will be improved while also achieving a tensile strength TS higher than 570 MPa:

$$( 1 )$$

$$Si / 28 + Ti / 48 + Nb / 93 + V / 51 + Zr / 91 + Mo / 96 + Cr / 52 > C / 12 \times 750$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

However, even when non-oriented electrical steel sheets satisfied the feature described above, although the non-oriented electrical steel sheets had high strength and excellent magnetic properties, there were still cases where sufficient dimensional accuracy could not be obtained after blanking. Hence, the present inventors conducted further studies and obtained the following finding.

When performing blanking, the amount of springback increases as work hardening progresses. However, if the percent elongation at yield at which deformation proceeds without work hardening is increased, non-uniformity of deformation in the thickness direction will be reduced and, as a result, the dimensional accuracy will improve. If the yield elongation is 0.5% or more, the dimensional accuracy after blanking will be further improved.

On the other hand, a tendency for the yield elongation to decrease as the content of Si was increased was observed. The reason for this is believed to be as follows. As mentioned above, it is considered that Si suppresses entanglement of dislocations and thereby contributes to the suppression of work hardening. However, work hardening is also caused by the pile-up of dislocations. If the content of Si is increased, because slip systems are restricted, dislocation generation sources are limited. It is considered that, as a result, the yield elongation decreases.

Based on the above finding, the present inventors believed that increasing the dislocation generation sources and dispersing the dislocation generation source would be effective for increasing the yield elongation. As a result of further studies, it was revealed that when the grain size is made small in order to increase the number of crystal grain boundaries, which are dislocation generation sources, the yield elongation increases. Specifically, the present inventors have discovered that if an average grain size D satisfies Formula (4), it will be easy for the yield elongation to become 0.5% or more, and the dimensional accuracy of a blanked product after blanking will improve:

$$D < 80 - Si \times 10 \qquad ( 4 )$$

where, the content of Si in percent by mass in the non-oriented electrical steel sheet is substituted for Si in Formula (4).

The gist of the non-oriented electrical steel sheet of the present embodiment, which has been completed based on the technical idea described above, is as follows.

A non-oriented electrical steel sheet according to a first aspect consists of, in mass %, Si: 3.1 to 4.5%, C: 0.0025% or less, N: 0.0025% or less, O: 0.0% or less, P: 0.100% or less, S: 0.0050% or less, Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, Ce: 0 to 0.0100%, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%, with the balance being Fe and impurities, and satisfies Formula (1) and Formula (2):

$$( 1 )$$

$$Si / 28 + Ti / 48 + Nb / 93 + V / 51 + Zr / 91 + Mo / 96 + Cr / 52 > C / 12 \times 750$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

In the non-oriented electrical steel sheet, in addition, a tensile strength TS is higher than 570 MPa.

In the non-oriented electrical steel sheet, furthermore, when a stress at 2.0% strain is expressed as Y_{2.0} (MPa) and a yield stress is expressed as YS (MPa), a work hardening amount WH defined by Formula (3) is less than 15 MPa.

$$WH = {Y}_{2.} - YS \qquad ( 3 )$$

In the non-oriented electrical steel sheet according to the first aspect, in addition, an average grain size D (μm) satisfies Formula (4), and a yield elongation is 0.5% or more:

$$D < 80 - Si \times 10 \qquad ( 4 )$$

where, a content of a corresponding element in percent by mass is substituted for a symbol of an element in Formula (4), and if the corresponding element is not contained, “0” is substituted for the symbol of the corresponding element.

A non-oriented electrical steel sheet according to a second aspect is in accordance with the non-oriented electrical steel sheet according to the first aspect, wherein the non-oriented electrical steel sheet contains one or more types of element selected from a group consisting of, in mass %, Zr: 0.0001 to 0.0100%, Nb: 0.0001 to 0.0100%, V: 0.0001 to 0.0100%, Mo: 0.001 to 0.100%, Cr: 0.001 to 2.000%, La: 0.0001 to 0.0100%, Ce: 0.0001 to 0.0100%, B: 0.0001 to 0.0010%, Zn: 0.0001 to 0.0050%, Ga: 0.0001 to 0.0050%, Ge: 0.0001 to 0.0050%, As: 0.0001 to 0.0100%, Ni: 0.001 to 0.500%, Cu: 0.001 to 0.500%, Sn: 0.001 to 0.200%, Sb: 0.001 to 0.100%, Ca: 0.0001 to 0.0050%, Nd: 0.0001 to 0.0010%, and Mg: 0.0001 to 0.0030%.

A rotor core according to a first aspect includes a plurality of rotor core starting materials stacked together.

The rotor core starting material consists of, in mass %, Si: 3.1 to 4.5%, C: 0.0025% or less, N: 0.0025% or less, O: 0.0400% or less, P: 0.100% or less, S: 0.0050% or less, Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, Ce: 0 to 0.0100%, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%, with the balance being Fe and impurities, and satisfies Formula (1) and Formula (2):

$$( 1 )$$

$$Si / 28 + Ti / 48 + Nb / 93 + V / 51 + Zr / 91 + Mo / 96 + Cr / 52 > C / 12 \times 750$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

In the rotor core starting material, in addition, a tensile strength TS is higher than 570 MPa.

In the rotor core starting material, furthermore, when a stress at 2.0% strain is expressed as Y_{2.0} (MPa) and a yield stress is expressed as YS (MPa), a work hardening amount WH defined by Formula (3) is less than 15 MPa.

$$WH = {Y}_{2.} - YS \qquad ( 3 )$$

In the rotor core starting material, in addition, an average grain size D (μm) satisfies Formula (4), and a yield elongation is 0.5% or more:

$$D < 80 - Si \times 10 \qquad ( 4 )$$

where, a content of a corresponding element in percent by mass is substituted for a symbol of an element in Formula (4), and if the corresponding element is not contained, “0” is substituted for the symbol of the corresponding element.

A rotor core according to a second aspect is in accordance with the rotor core according to the first aspect, wherein the rotor core starting material contains one or more types of element selected from a group consisting of, in mass %, Zr: 0.0001 to 0.0100%, Nb: 0.0001 to 0.0100%, V: 0.0001 to 0.0100%, Mo: 0.001 to 0.100%, Cr: 0.001 to 2.000%, La: 0.0001 to 0.0100%, Ce: 0.0001 to 0.0100%, B: 0.0001 to 0.0010%, Zn: 0.0001 to 0.0050%, Ga: 0.0001 to 0.0050%, Ge: 0.0001 to 0.0050%, As: 0.0001 to 0.0100%, Ni: 0.001 to 0.500%, Cu: 0.001 to 0.500%, Sn: 0.001 to 0.200%, Sb: 0.001 to 0.100%, Ca: 0.0001 to 0.0050%, Nd: 0.0001 to 0.0010%, and Mg: 0.0001 to 0.0030%.

A motor of the present embodiment includes the rotor core according to the first or second aspect.

A method for producing a non-oriented electrical steel sheet of the present embodiment is a method for producing the non-oriented electrical steel sheet according to the first or second aspect, and includes a hot rolling process, a cold rolling process, and a final annealing process.

In the hot rolling process, a slab is subjected to hot rolling to produce a hot-rolled steel sheet.

In the cold rolling process, the hot-rolled steel sheet is subjected to cold rolling to produce a cold-rolled steel sheet.

In the final annealing process, the cold-rolled steel sheet is subjected to final annealing in a final annealing furnace.

In the final annealing process, in addition, the cold-rolled steel sheet is annealed at a maximum attainment temperature T1 of 950° C. or less. Further, a tension TE applied to the cold-rolled steel sheet at the maximum attainment temperature T1 is set to 2.0 to 10.0 MPa. In addition, a residence time t0 (seconds) from an annealing temperature T1 to 700° C. in a heating zone, a soaking zone, and a cooling zone of the final annealing furnace, and a residence time t1 (seconds) from 700 to 500° C. in the cooling zone are set to satisfy Formula (A) and Formula (B).

$$t 1 - t 0 > 0 \qquad ( A )$$

$$t 1 / t 0 \leq 3. \qquad ( B )$$

In addition, at one location or more selected from the heating zone, the soaking zone, and the cooling zone in a temperature range of 500° C. or more in a furnace atmosphere of the final annealing furnace, a ratio of a water vapor partial pressure P_{H20} (atm) to a hydrogen partial pressure P_{H2} (atm) is made higher than 0.05, or an oxygen concentration is made higher than 0.010%.

Further, a temperature gradient CG in a longitudinal direction of the cold-rolled steel sheet in a cooling process is made 20° C./m or less.

Hereunder, the non-oriented electrical steel sheet of the present embodiment will be described in detail.

### [Features of Non-Oriented Electrical Steel Sheet of Present Embodiment]

The non-oriented electrical steel sheet of the present embodiment satisfies the following feature 1 to feature 5.

### (Feature 1)

The chemical composition consists of, in mass %, Si: 3.1 to 4.5%, C: 0.0025% or less, N: 0.0025% or less, O: 0.0400% or less, P: 0.100% or less, S: 0.0050% or less, Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, Ce: 0 to 0.0100%, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%, with the balance being Fe and impurities.

### (Feature 2)

The chemical composition described above, in addition, satisfies Formula (1) and Formula (2):

$$( 1 )$$

$$Si / 28 + Ti / 48 + Nb / 93 + V / 51 + Zr / 91 + Mo / 96 + Cr / 52 > C / 12 \times 750$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

### (Feature 3)

A tensile strength TS is higher than 570 MPa.

### (Feature 4)

When a stress at 2.0% strain is expressed as Y_{2.0} (MPa) and a yield stress is expressed as YS (MPa), a work hardening amount WH defined by Formula (3) is less than 15 MPa.

$$WH = {Y}_{2.} - YS \qquad ( 3 )$$

$$( Feature 5 )$$

An average grain size D (μm) satisfies Formula (4), and a yield elongation is 0.5% or more:

$$D < 80 - Si \times 10 \qquad ( 4 )$$

where, a content of the corresponding element in percent by mass is substituted for a symbol of an element in Formula (4).

Feature 1 to feature 5 are described hereunder.

### [(Feature 1) Regarding Chemical Composition]

The chemical composition of the non-oriented electrical steel sheet of the present embodiment contains the following elements. Note that, the symbol “%” in relation to the contents of elements in the chemical composition of the non-oriented electrical steel sheet and the rotor core starting material means “mass percent” unless specifically stated otherwise. Further, the non-oriented electrical steel sheet is also referred to simply as “steel sheet”.

### Si: 3.1 to 4.5%

Silicon (Si) increases the resistivity of the steel sheet and reduces eddy-current loss. Si also dissolves in the steel sheet and increases the strength of the non-oriented electrical steel sheet. In addition, Si restricts slip systems along which dislocations can move. By this means, Si can suppress entanglement of dislocations and can suppress an increase in dislocation density. Therefore, the dimensional accuracy after blanking can be increased. If the content of Si is less than 3.1%, the aforementioned advantageous effects will not be sufficiently obtained.

On the other hand, if the content of Si is more than 4.5%, the blanking workability of the non-oriented electrical steel sheet will decrease.

Therefore, the content of Si is 3.1 to 4.5%.

A preferable lower limit of the content of Si is 3.2%, more preferably is 3.3%, and further preferably is 3.4%.

A preferable upper limit of the content of Si is 4.4%, more preferably is 4.3%, and further preferably is 4.2%.

### C: 0.0025% or Less

Carbon (C) is unavoidably contained. That is, the content of C is more than 0%. C increases the strength of the steel sheet.

However, if the content of C is more than 0.0025%, the amount of dissolved C in the steel sheet will be excessively large. In such case, dissolved C will fix to dislocations during blanking and will restrict movement of the dislocations. If the amount of dislocations to which dissolved C is fixed is large, the density of dislocations that entangle with each other will also increase. As a result, unevenness will be likely to occur on the blanked product after blanking, and the dimensional accuracy after blanking will decrease. If the content of C is more than 0.0025%, in addition, an excessively large amount of carbides and/or carbo-nitrides will form. As a result, iron loss will deteriorate.

Therefore, the content of C is 0.0025% or less.

A preferable lower limit of the content of C is 0.0001%, more preferably is 0.0005%, further preferably is 0.0010%, further preferably is 0.0012%, further preferably is 0.0014%, and further preferably is 0.0016%.

A preferable upper limit of the content of C is 0.0024%, more preferably is 0.0023%, further preferably is 0.0022%, and further preferably is 0.0021%.

### N: 0.0025% or Less

Nitrogen (N) is unavoidably contained. That is, the content of N is more than 0%. N increases the strength of the steel sheet. If even a small amount of N is contained, the aforementioned advantageous effect will be obtained to a certain extent.

However, if the content of N is more than 0.0025%, the amount of dissolved N in the steel sheet will be excessively large. In such case, dissolved N will fix to dislocations during blanking and will restrict movement of the dislocations. If the amount of dislocations to which dissolved N is fixed is large, the density of dislocations that entangle with each other will also increase. As a result, unevenness will be likely to occur on the blanked product after blanking, and the dimensional accuracy after blanking will decrease. If the content of N is more than 0.0025%, in addition, an excessively large amount of nitrides and/or carbo-nitrides will form. As a result, iron loss will deteriorate.

Therefore, the content of N is 0.0025% or less.

A preferable lower limit of the content of N is 0.0001%, more preferably is 0.0005%, further preferably is 0.0010%, further preferably is 0.0012%, further preferably is 0.0014%, and further preferably is 0.0016%.

A preferable upper limit of the content of N is 0.0024%, more preferably is 0.0023%, further preferably is 0.0022%, and further preferably is 0.0021%.

### O: 0.0400% or Less

Oxygen (O) is unavoidably contained. That is, the content of O is more than 0%. O forms oxides and reduces the magnetic properties of the steel sheet.

Therefore, the content of O is 0.0400% or less.

The content of O is preferably as low as possible. However, excessively reducing the content of O will increase the production cost. Therefore, from the viewpoint of industrial productivity, a preferable lower limit of the content of O is 0.0001%, more preferably is 0.0010%, and further preferably is 0.0020%.

A preferable upper limit of the content of O is 0.0370%, more preferably is 0.0350%, further preferably is 0.0300%, and further preferably is 0.0200%.

### P: 0.100% or Less

Phosphorus (P) is unavoidably contained. That is, the content of P is more than 0%. P increases the strength of the steel sheet. If even a small amount of P is contained, the aforementioned advantageous effect will be obtained to a certain extent.

However, if the content of P is more than 0.100%, the steel sheet will become brittle and workability will decrease, and cracks may occur in the steel sheet during cold rolling.

Therefore, the content of P is 0.100% or less.

A preferable lower limit of the content of P is 0.001%, more preferably is 0.005%, and further preferably is 0.007%.

A preferable upper limit of the content of P is 0.090%, more preferably is 0.080%, and further preferably is 0.070%.

### S: 0.0050% or Less

Sulfur (S) is an impurity that is unavoidably contained. That is, the content of S is more than 0%. S forms MnS and causes a deterioration in iron loss.

Therefore, the content of S is 0.0050% or less.

The content of S is preferably as low as possible. However, excessively reducing the content of S will increase the production cost. Therefore, from the viewpoint of industrial productivity, a preferable lower limit of the content of S is 0.0001%, more preferably is 0.0003%, and further preferably is 0.0005%.

A preferable upper limit of the content of S is 0.0047%, more preferably is 0.0045%, further preferably is 0.0040%, further preferably is 0.0030%, further preferably is 0.0025%, and further preferably is 0.0020%.

[Regarding Elements that Decrease Dissolved C and/or Dissolved N]

The chemical composition of the non-oriented electrical steel sheet of the present embodiment further contains Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, and Ce: 0 to 0.0100%. Each of these elements fixes dissolved C and/or dissolved N in the steel sheet to form precipitates such as carbides, carbo-nitrides, or nitrides. As a result, these elements decrease the amount of dissolved C and dissolved N which are factors that reduce the dimensional accuracy after blanking.

### Ti: 0.0100% or Less

Titanium (Ti) is unavoidably contained. That is, the content of Ti is more than 0%. Ti combines with C and/or N to form precipitates, and thereby decreases the amount of dissolved C and dissolved N. By this means, Ti increases the dimensional accuracy after blanking. Ti also increases the strength of the steel sheet by formation of the precipitates. If even a small amount of Ti is contained, the aforementioned advantageous effects will be obtained to a certain extent.

However, if the content of Ti is more than 0.0100%, precipitates will excessively form and the magnetic properties will deteriorate.

Therefore, the content of Ti is 0.0100% or less.

A preferable lower limit of the content of Ti is 0.0001%, more preferably is 0.0005%, and further preferably is 0.0010%.

A preferable upper limit of the content of Ti is 0.0090%, more preferably is 0.0080%, further preferably is 0.0070%, further preferably is 0.0060%, and further preferably is 0.0055%.

### Mn: 2.0% or Less

Manganese (Mn) is unavoidably contained. That is, the content of Mn is more than 0%. Mn combines with C to form carbides, and thereby decreases the amount of dissolved C. Mn also increases the resistivity of the steel sheet, and thereby reduces eddy-current loss. If even a small amount of Mn is contained, the aforementioned advantageous effects will be obtained to a certain extent.

However, if the content of Mn is more than 2.0%, the magnetic flux density of the steel sheet will decrease.

Therefore, the content of Mn is 2.0% or less.

A preferable lower limit of the content of Mn is 0.1%, more preferably is 0.2%, and further preferably is 0.5%.

A preferable upper limit of the content of Mn is 1.8%, more preferably is 1.6%, and further preferably is 1.4%.

### Al: 1.500% or Less

Aluminum (Al) is unavoidably contained. That is, the content of Al is more than 0%. Al combines with N to form nitrides, and thereby decreases the amount of dissolved N. Thus, the dimensional accuracy after blanking increases. Al also increases the strength of the steel sheet by formation of the nitrides. If even a small amount of Al is contained, the aforementioned advantageous effects will be obtained to a certain extent.

However, if the content of Al is more than 1.500%, oxides will excessively form in the steel sheet and the magnetic properties will deteriorate.

Therefore, the content of Al is 1.500% or less.

A preferable lower limit of the content of Al is 0.001%, more preferably is 0.004%, further preferably is 0.005%, further preferably is 0.010%, further preferably is 0.050%, and further preferably is 0.100%.

A preferable upper limit of the content of Al is 1.450%, more preferably is 1.400%, further preferably is 1.300%, further preferably is 1.100%, and further preferably is 0.900%.

Note that, in the present description, the term “content of Al” means the content of sol. Al (acid-soluble Al).

### Zr: 0 to 0.0100%

Zirconium (Zr) does not have to be contained. That is, the content of Zr may be 0%.

When contained, in other words, when the content of Zr is more than 0%, Zr combines with C and/or N to form precipitates, and thereby decreases the amount of dissolved C and dissolved N. By this means, Zr increases the dimensional accuracy after blanking. Zr also increases the strength of the steel sheet by formation of the precipitates. If even a small amount of Zr is contained, the aforementioned advantageous effects will be obtained to a certain extent.

However, if the content of Zr is more than 0.0100%, precipitates will excessively form. In such case, the magnetic properties will deteriorate.

Therefore, the content of Zr is 0 to 0.0100%.

A preferable lower limit of the content of Zr is 0.0001%, more preferably is 0.0005%, and further preferably is 0.0010%.

A preferable upper limit of the content of Zr is 0.0095%, more preferably is 0.0090%, further preferably is 0.0080%, and further preferably is 0.0070%.

### Nb: 0 to 0.0100%

Niobium (Nb) does not have to be contained. That is, the content of Nb may be 0%.

When contained, Nb combines with C to form carbides, and thereby decreases the amount of dissolved C. By this means, Nb increases the dimensional accuracy after blanking. Nb also increases the strength of the steel sheet by formation of the carbides. If even a small amount of Nb is contained, the aforementioned advantageous effects will be obtained to a certain extent.

However, if the content of Nb is more than 0.0100%, carbides will excessively form. In such case, the magnetic properties will deteriorate.

Therefore, the content of Nb is 0 to 0.0100%.

A preferable lower limit of the content of Nb is 0.0001%, more preferably is 0.0005%, and further preferably is 0.0010%.

A preferable upper limit of the content of Nb is 0.0090%, more preferably is 0.0080%, further preferably is 0.0070%, further preferably is 0.0050%, further preferably is 0.0040%, further preferably is 0.0030%, and further preferably is 0.0025%.

### V: 0 to 0.0100%

Vanadium (V) does not have to be contained. That is, the content of V may be 0%.

When contained, in other words, when the content of V is more than 0%, V combines with C to form carbides, and thereby decreases the amount of dissolved C. By this means, V increases the dimensional accuracy after blanking. V also increases the strength of the steel sheet by formation of the carbides. If even a small amount of V is contained, the aforementioned advantageous effects will be obtained to a certain extent.

However, if the content of V is more than 0.0100%, carbides will excessively form. In such case, the magnetic properties will deteriorate.

Therefore, the content of V is 0 to 0.0100%.

A preferable lower limit of the content of V is 0.0001%, more preferably is 0.0005%, and further preferably is 0.0010%.

A preferable upper limit of the content of V is 0.0090%, more preferably is 0.0080%, further preferably is 0.0070%, further preferably is 0.0050%, further preferably is 0.0040%, further preferably is 0.0030%, and further preferably is 0.0025%.

### Mo: 0 to 0.100%

Molybdenum (Mo) does not have to be contained. That is, the content of Mo may be 0%.

When contained, in other words, when the content of Mo is more than 0%, Mo combines with C to form carbides, and thereby decreases the amount of dissolved C. By this means, Mo increases the dimensional accuracy after blanking. Mo also increases the strength of the steel sheet by formation of the carbides. If even a small amount of Mo is contained, the aforementioned advantageous effects will be obtained to a certain extent.

However, if the content of Mo is more than 0.100%, carbides will excessively form. In such case, the magnetic properties will deteriorate.

Therefore, the content of Mo is 0 to 0.100%.

A preferable lower limit of the content of Mo is 0.001%, more preferably is 0.005%, further preferably is 0.010%, and further preferably is 0.030%.

A preferable upper limit of the content of Mo is 0.090%, more preferably is 0.080%, and further preferably is 0.070%.

### Cr: 0 to 2.000%

Chromium (Cr) does not have to be contained. That is, the content of Cr may be 0%.

When contained, in other words, when the content of Cr is more than 0%, Cr combines with C to form carbides, and thereby decreases the amount of dissolved C. By this means, Cr increases the dimensional accuracy after blanking. Cr also increases the strength of the steel sheet. If even a small amount of Cr is contained, the aforementioned advantageous effects will be obtained to a certain extent.

However, if the content of Cr is more than 2.000%, carbides will excessively form. In such case, the magnetic properties will deteriorate.

Therefore, the content of Cr is 0 to 2.000%.

A preferable lower limit of the content of Cr is 0.001%, more preferably is 0.005%, further preferably is 0.010%, and further preferably is 0.050%.

A preferable upper limit of the content of Cr is 1.800%, more preferably is 1.500%, further preferably is 1.400%, and further preferably is 1.000%.

### La: 0 to 0.0100%

Lanthanum (La) is an optional element, and does not have to be contained. That is, the content of La may be 0%.

When contained, in other words, when the content of La is more than 0%, La combines with N to form nitrides, and thereby decreases the amount of dissolved N. By this means, La increases the dimensional accuracy after blanking. La also increases the strength of the steel sheet by formation of the nitrides. If even a small amount of La is contained, the aforementioned advantageous effects will be obtained to a certain extent.

However, if the content of La is more than 0.0100%, nitrides will excessively form in the steel sheet. In such case, the magnetic properties will deteriorate.

Therefore, the content of La is 0 to 0.0100%.

A preferable lower limit of the content of La is 0.0001%, more preferably is 0.0005%, further preferably is 0.0010%, and further preferably is 0.0020%.

A preferable upper limit of the content of La is 0.0090%, more preferably is 0.0080%, further preferably is 0.0075%, and further preferably is 0.0070%.

### Ce: 0 to 0.0100%

Cerium (Ce) is an optional element, and does not have to be contained. That is, the content of Ce may be 0%.

When contained, in other words, when the content of Ce is more than 0%, Ce combines with N to form nitrides, and thereby decreases the amount of dissolved N. By this means, Ce increases the dimensional accuracy after blanking. Ce also increases the strength of the steel sheet by formation of the nitrides. If even a small amount of Ce is contained, the aforementioned advantageous effects will be obtained to a certain extent.

However, if the content of Ce is more than 0.0100%, nitrides will excessively form in the steel sheet. In such case, the magnetic properties will deteriorate.

Therefore, the content of Ce is 0 to 0.0100%.

A preferable lower limit of the content of Ce is 0.0001%, more preferably is 0.0005%, further preferably is 0.0010%, and further preferably is 0.0015%.

A preferable upper limit of the content of Ce is 0.0090%, more preferably is 0.0080%, and further preferably is 0.0070%.

The balance of the chemical composition of the non-oriented electrical steel sheet of the present embodiment is Fe and impurities. Here, the term “impurities” refers to substances which, when industrially producing the non-oriented electrical steel sheet, are mixed in from ore or scrap used as a raw material or from the production environment or the like. Contents of these impurities are allowed within a range that does not adversely affect the non-oriented electrical steel sheet of the present embodiment.

The non-oriented electrical steel sheet of the present embodiment may contain, in addition, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%. Each of these elements is an optional element, and does not have to be contained. Hereunder, each element will be described.

### [B, Zn, Ga, Ge, and As]

B, Zn, Ga, Ge, and As are impurities in the non-oriented electrical steel sheet of the present embodiment.

### B: 0 to 0.0010%

Boron (B) is an optional element, and does not have to be contained. That is, the content of B may be 0%.

When contained, in other words, when the content of B is more than 0%, B forms nitrides. The B nitrides inhibit recrystallization during final annealing.

Therefore, the content of B is 0 to 0.0010%.

Excessively reducing the content of B will increase the production cost. Therefore, from the viewpoint of industrial productivity, a preferable lower limit of the content of B is 0.0001%, more preferably is 0.0002%, and further preferably is 0.0003%.

A preferable upper limit of the content of B is 0.0009%, more preferably is 0.0008%, and further preferably is 0.0007%.

### Zn: 0 to 0.0050%

Zinc (Zn) is an optional element, and does not have to be contained. That is, the content of Zn may be 0%.

When contained, in other words, when the content of Zn is more than 0%, no particular problem occurs as long as the content of Zn is 0.0050% or less.

Therefore, the content of Zn is 0 to 0.0050%.

Excessively reducing the content of Zn will increase the production cost. Therefore, from the viewpoint of industrial productivity, a preferable lower limit of the content of Zn is 0.0001%, more preferably is 0.0002%, and further preferably is 0.0003%.

A preferable upper limit of the content of Zn is 0.0020%, more preferably is 0.0010%, and further preferably is 0.0005%.

### Ga: 0 to 0.0050%

Gallium (Ga) is an optional element, and does not have to be contained. That is, the content of Ga may be 0%.

When contained, in other words, when the content of Ga is more than 0%, no particular problem occurs as long as the content of Ga is 0.0050% or less.

Therefore, the content of Ga is 0 to 0.0050%.

Excessively reducing the content of Ga will increase the production cost. Therefore, from the viewpoint of industrial productivity, a preferable lower limit of the content of Ga is 0.0001%, more preferably is 0.0002%, and further preferably is 0.0003%.

A preferable upper limit of the content of Ga is 0.0040%, more preferably is 0.0035%, further preferably is 0.0030%, further preferably is 0.0020%, further preferably is 0.0010%, and further preferably is 0.0005%.

### Ge: 0 to 0.0050%

Germanium (Ge) is an optional element, and does not have to be contained. That is, the content of Ge may be 0%.

When contained, in other words, when the content of Ge is more than 0%, no particular problem occurs as long as the content of Ge is 0.0050% or less.

Therefore, the content of Ge is 0 to 0.0050%.

Excessively reducing the content of Ge will increase the production cost. Therefore, from the viewpoint of industrial productivity, a preferable lower limit of the content of Ge is 0.0001%, more preferably is 0.0002%, and further preferably is 0.0003%.

A preferable upper limit of the content of Ge is 0.0040%, more preferably is 0.0035%, further preferably is 0.0030%, further preferably is 0.0020%, further preferably is 0.0010%, and further preferably is 0.0005%.

### As: 0 to 0.0100%

Arsenic (As) is an optional element, and does not have to be contained. That is, the content of As may be 0%.

When contained, in other words, when the content of As is more than 0%, no particular problem occurs as long as the content of As is 0.0100% or less.

Therefore, the content of As is 0 to 0.0100%.

Excessively reducing the content of As will increase the production cost. Therefore, from the viewpoint of industrial productivity, a preferable lower limit of the content of As is 0.0001%, more preferably is 0.0002%, further preferably is 0.0003%, further preferably is 0.0005%, and further preferably is 0.0010%.

A preferable upper limit of the content of As is 0.0070%, more preferably is 0.0060%, further preferably is 0.0050%, and further preferably is 0.0030%.

### [Ni and Cu]

Ni and Cu are optional elements. Ni and Cu each increase the strength of the non-oriented electrical steel sheet.

### Ni: 0 to 0.500%

Nickel (Ni) is an optional element, and does not have to be contained. That is, the content of Ni may be 0%.

When contained, in other words, when the content of Ni is more than 0%, Ni increases the strength of the non-oriented electrical steel sheet. If even a small amount of Ni is contained, the aforementioned advantageous effect will be obtained to a certain extent.

However, if the content of Ni is more than 0.500%, the steel sheet will become brittle and workability will decrease.

Therefore, the content of Ni is 0 to 0.500%.

A preferable lower limit of the content of Ni is 0.001%, more preferably is 0.005%, further preferably is 0.010%, further preferably is 0.020%, further preferably is 0.050%, and further preferably is 0.100%.

A preferable upper limit of the content of Ni is 0.450%, more preferably is 0.400%, further preferably is 0.350%, further preferably is 0.300%, and further preferably is 0.250%.

### Cu: 0 to 0.500%

Copper (Cu) is an optional element, and does not have to be contained. That is, the content of Cu may be 0%.

When contained, in other words, when the content of Cu is more than 0%, Cu increases the strength of the non-oriented electrical steel sheet. If even a small amount of Cu is contained, the aforementioned advantageous effect will be obtained to a certain extent.

However, if the content of Cu is more than 0.500%, the steel sheet will become brittle and workability will decrease.

Therefore, the content of Cu is 0 to 0.500%.

A preferable lower limit of the content of Cu is 0.001%, more preferably is 0.005%, further preferably is 0.010%, further preferably is 0.030%, further preferably is 0.050%, and further preferably is 0.100%.

A preferable upper limit of the content of Cu is 0.450%, more preferably is 0.400%, further preferably is 0.350%, further preferably is 0.250%, and further preferably is 0.150%.

### [Sn and Sb]

Sn and Sb are optional elements. Sn and Sb each decrease the iron loss of the non-oriented electrical steel sheet.

### Sn: 0 to 0.200%

Tin (Sn) is an optional element, and does not have to be contained. That is, the content of Sn may be 0%.

When contained, in other words, when the content of Sn is more than 0%, Sn segregates to the surface of the steel sheet and suppresses oxidation and nitriding during final annealing. In addition, Sn improves the texture of the steel sheet and thereby increases the magnetic flux density. As a result, iron loss of the non-oriented electrical steel sheet decreases. If even a small amount of Sn is contained, the aforementioned advantageous effect will be obtained to a certain extent.

However, if the content of Sn is more than 0.200%, the steel sheet will become brittle and workability will decrease.

Therefore, the content of Sn is 0 to 0.200%.

A preferable lower limit of the content of Sn is 0.001%, more preferably is 0.003%, further preferably is 0.005%, further preferably is 0.010%, further preferably is 0.030%, and further preferably is 0.050%.

A preferable upper limit of the content of Sn is 0.180%, more preferably is 0.160%, further preferably is 0.150%, and further preferably is 0.120%.

### Sb: 0 to 0.100%

Antimony (Sb) is an optional element, and does not have to be contained. That is, the content of Sb may be 0%.

When contained, in other words, when the content of Sb is more than 0%, similarly to Sn, Sb segregates to the surface of the steel sheet and suppresses oxidation and nitriding during final annealing. In addition, Sb improves the texture of the steel sheet and thereby increases the magnetic flux density. As a result, iron loss of the non-oriented electrical steel sheet decreases. If even a small amount of Sb is contained, the aforementioned advantageous effect will be obtained to a certain extent.

However, if the content of Sb is more than 0.100%, the steel sheet will become brittle and workability will decrease.

Therefore, the content of Sb is 0 to 0.100%.

A preferable lower limit of the content of Sb is 0.001%, more preferably is 0.005%, further preferably is 0.010%, and further preferably is 0.030%.

A preferable upper limit of the content of Sb is 0.080%, more preferably is 0.070%, further preferably is 0.060%, and further preferably is 0.050%.

### [Ca, Nd, and Mg]

Ca, Nd, and Mg are optional elements. Ca, Nd, and Mg each promote the growth of grains during final annealing, and enhance the magnetic properties of the non-oriented electrical steel sheet.

### Ca: 0 to 0.0050%

Calcium (Ca) is an optional element, and does not have to be contained. That is, the content of Ca may be 0%.

When contained, in other words, when the content of Ca is more than 0%, Ca combines with S during casting of molten steel and forms coarse precipitates that are coarse sulfides and/or coarse oxysulfides. The grain size of the coarse precipitates is approximately 1 to 2 μm. The coarse precipitates adsorb fine inhibitors such as MnS, TiN, and AlN that have a grain size of approximately 100 nm which are formed in the steel sheet during the production process from the casting process onward. By this means, inhibition of grain growth by inhibitors is suppressed during final annealing. Consequently, the growth of grains is promoted during final annealing. As a result, the magnetic properties of the non-oriented electrical steel sheet are enhanced. If even a small amount of Ca is contained, the aforementioned advantageous effect will be obtained to a certain extent.

However, if the content of Ca is more than 0.0050%, coarse precipitates will excessively form. In such case, recrystallization and the growth of grains will be inhibited during the final annealing process.

Therefore, the content of Ca is 0 to 0.0050%.

A preferable lower limit of the content of Ca is 0.0001%, more preferably is 0.0005%, and further preferably is 0.0010%.

A preferable upper limit of the content of Ca is 0.0045%, more preferably is 0.0040%, and further preferably is 0.0035%.

### Nd: 0 to 0.0010%

Neodymium (Nd) is an optional element, and does not have to be contained. That is, the content of Nd may be 0%.

When contained, in other words, when the content of Nd is more than 0%, similarly to Ca, Nd forms coarse precipitates and thereby suppresses inhibition of the growth of grains by inhibitors during final annealing. Consequently, the growth of grains is promoted during final annealing. As a result, the magnetic properties of the non-oriented electrical steel sheet are enhanced. If even a small amount of Nd is contained, the aforementioned advantageous effect will be obtained to a certain extent.

However, if the content of Nd is more than 0.0010%, coarse precipitates will excessively form. In such case, recrystallization and the growth of grains will be inhibited during the final annealing process.

Therefore, the content of Nd is 0 to 0.0010%.

A preferable lower limit of the content of Nd is 0.0001%, more preferably is 0.0002%, and further preferably is 0.0003%.

A preferable upper limit of the content of Nd is 0.0008%, more preferably is 0.0006%, and further preferably is 0.0004%.

### Mg: 0 to 0.0030%

Magnesium (Mg) is an optional element, and does not have to be contained. That is, the content of Mg may be 0%.

When contained, in other words, when the content of Mg is more than 0%, similarly to Ca, Mg forms coarse precipitates and thereby suppresses inhibition of the growth of grains by inhibitors during final annealing. Consequently, the growth of grains is promoted during final annealing. As a result, the magnetic properties of the non-oriented electrical steel sheet are enhanced. If even a small amount of Mg is contained, the aforementioned advantageous effect will be obtained to a certain extent.

However, if the content of Mg is more than 0.0030%, coarse precipitates will excessively form. In such case, recrystallization and the growth of grains will be inhibited during the final annealing process.

Therefore, the content of Mg is 0 to 0.0030%.

A preferable lower limit of the content of Mg is 0.0001%, more preferably is 0.0002%, and further preferably is 0.0003%.

A preferable upper limit of the content of Mg is 0.0025%, more preferably is 0.0020%, further preferably is 0.0015%, and further preferably is 0.0010%.

### [Method for Measuring Chemical Composition of Non-Oriented Electrical Steel Sheet]

The chemical composition of the non-oriented electrical steel sheet of the present embodiment can be measured by a well-known composition analysis method in accordance with JIS G0321: 2017. Specifically, a drill is used to collect a machined chip from the steel sheet. The collected machined chip is dissolved in acid to obtain a liquid solution. The liquid solution is subjected to ICP-AES (Inductively Coupled Plasma Atomic Emission Spectrometry) to perform elemental analysis of the chemical composition. The content of C and the content of S are determined by a well-known high-frequency combustion method (combustion-infrared absorption method). The content of N is determined using a well-known inert gas fusion-thermal conductivity method. The content of O is determined using a well-known inert gas fusion-infrared absorption method.

Note that, the content of each element is taken as a numerical value up to the least significant digit of the content of each element defined in the present embodiment that is obtained by rounding off a fraction of the measured numerical value based on the significant figures defined in the present embodiment. For example, the content of Si in the steel sheet of the present embodiment is defined as a numerical value up to the first decimal place. Therefore, the content of Si is taken as a numerical value up to the first decimal place that is obtained by rounding off the second decimal place of the measured numerical value.

Similarly, for the content of each element other than the content of Si in the steel sheet of the present embodiment also, a value obtained by rounding off a fraction of the numerical value of the measured value up to the least significant digit defined in the present embodiment is taken as the content of the relevant element.

Note that, the term “rounding off” means rounding down if the fraction is less than 5, and rounding up if the fraction is 5 or more.

### [(Feature 2) Regarding Formula (1) and Formula (2)]

The non-oriented electrical steel sheet of the present embodiment also satisfies Formula (1) and Formula (2):

$$( 1 )$$

$$Si / 28 + Ti / 48 + Nb / 93 + V / 51 + Zr / 91 + Mo / 96 + Cr / 52 > C / 12 \times 750$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

### [Regarding Formula (1)]

Formula (1) is a formula for sufficiently decreasing the amount of dissolved C in the steel sheet by forming carbides or carbo-nitrides. The left-hand side of Formula (1) is composed of elements that combine with C to form carbides or carbo-nitrides. When Formula (1) is satisfied, the amount of dissolved C is sufficiently decreased because carbides or carbo-nitrides are sufficiently formed.

### [Regarding Formula (2)]

Formula (2) is a formula for sufficiently decreasing the amount of dissolved N in the steel sheet by forming nitrides or carbo-nitrides. The left-hand side of Formula (2) is composed of elements that combine with N to form nitrides or carbo-nitrides. When Formula (2) is satisfied, the amount of dissolved N is sufficiently decreased because nitrides or carbo-nitrides are sufficiently formed.

### [(Feature 3) Tensile Strength TS]

In the non-oriented electrical steel sheet of the present embodiment, the tensile strength TS is higher than 570 MPa. That is, the non-oriented electrical steel sheet of the present embodiment has high strength.

A preferable lower limit of the tensile strength TS of the non-oriented electrical steel sheet of the present embodiment is 575 MPa, and more preferably is 580 MPa.

The upper limit of the tensile strength TS is not particularly limited. However, in a case where feature 1 and feature 2 are satisfied, the upper limit of the tensile strength TS is, for example, 750 MPa.

### [Stress-Strain Curve Measurement Method]

The tensile strength TS of the non-oriented electrical steel sheet of the present embodiment is measured by the following method. A JIS No. 5 tensile test coupon defined in JIS Z 2241: 2011 is taken from the non-oriented electrical steel sheet. The taken tensile test specimen that is used to carry out a tensile test at normal temperature in the atmosphere in accordance with JIS Z 2241: 2011 to obtain a stress-strain curve. The tensile strength TS (MPa) is determined based on the obtained stress-strain curve.

### [(Feature 4) Regarding Work Hardening Amount WH]

In the non-oriented electrical steel sheet of the present embodiment, furthermore, when a stress at 2.0% strain is expressed as Y_{2.0} (MPa) and a yield stress is expressed as YS (MPa), a work hardening amount WH defined by Formula (3) is less than 15 MPa.

$$WH = {Y}_{2.} - YS \qquad ( 3 )$$

If dislocations multiply excessively during blanking, the possibility will increase that dislocations to which dissolved C or dissolved N is fixed will increase. If dislocations to which dissolved C or dissolved N is fixed increase, regions in which there is a high density of dislocations that are entangled with each other will be formed locally. In such case, unevenness will be likely to occur on a blanked product after blanking, and sufficient dimensional accuracy will not be obtained.

The work hardening amount WH correlates with the dislocation density. If the work hardening amount WH is less than 15 MPa, the dislocation density is sufficiently suppressed during blanking. Therefore, the occurrence of dislocations to which dissolved C or dissolved N is fixed can be sufficiently suppressed. Consequently, the occurrence of unevenness attributable to blanking on the blanked product after blanking will be suppressed, and sufficient dimensional accuracy will be obtained.

A preferable upper limit of the work hardening amount WH is 14 MPa, more preferably is 13 MPa, further preferably is 12 MPa, further preferably is 11 MPa, and further preferably is 10 MPa.

The work hardening amount WH is preferably as low as possible. When taking industrial productivity into consideration, a preferable lower limit of the work hardening amount WH is 2 MPa, more preferably is 1 MPa, and most preferably is 0 MPa.

### [Work Hardening Amount WH Evaluation Test]

The work hardening amount WH can be determined by the following method. A tensile test described above in the section [Stress-strain curve measurement method] is performed to obtain a stress-strain curve.

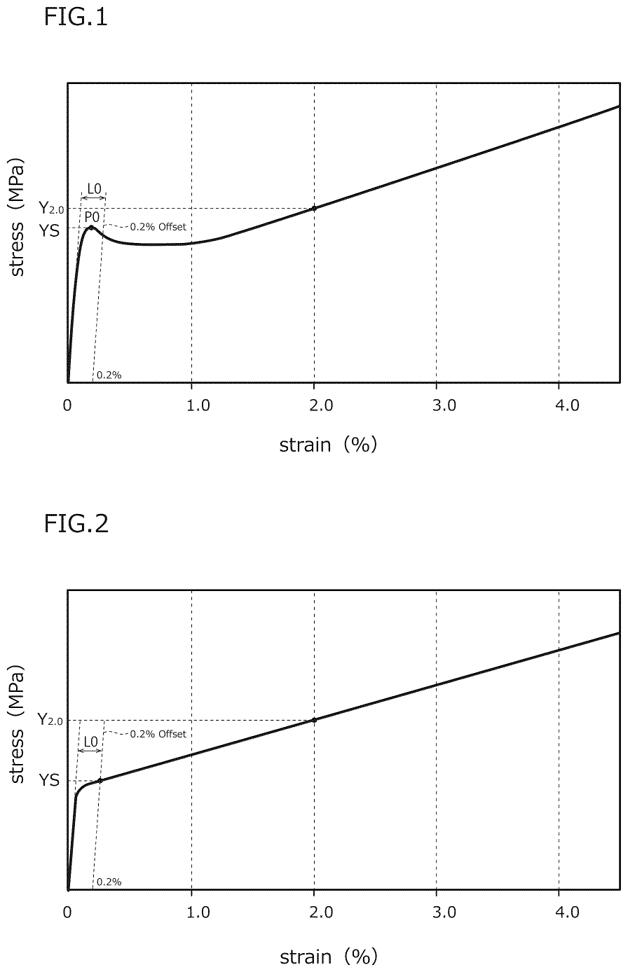

FIG. 1 is a schematic diagram of one example of a stress-strain curve. Referring to FIG. 1, the maximum value of stress when the strain is within a range from 0 to 0.2% plastic strain is defined as “yield strength YS” (MPa).

In FIG. 1, when the strain is within a range L0 from 0 to 0.2% plastic strain, an upper yield point P0 occurs on the stress-strain curve. Therefore, in a case where the stress-strain curve is a curve having an upper yield point as illustrated in FIG. 1, the stress at the upper yield point P0 is defined as the yield strength YS (MPa).

On the other hand, in a case where the stress-strain curve is a curve on which an upper yield point P0 does not occur, as in the stress-strain curve illustrated in FIG. 2, when the strain is within the range L0 from 0 to 0.2% plastic strain, the maximum value of stress is at the position of 0.2% plastic strain. Therefore, in this case, the 0.2% proof stress is defined as the yield strength YS (MPa).

Further, referring to FIG. 1 and FIG. 2, in the stress-strain curve, the stress at 2.0% strain is expressed as Y_{2.0} (MPa).

Using the obtained yield strength YS (MPa) and stress Y_{2.0} (MPa), the work hardening amount WH (MPa) is calculated by Formula (3). Note that, in a case where YS>Y_{2.0}, WH is defined as 0 (MPa).

### [(Feature 5) Regarding Average Grain Size D]

In the non-oriented electrical steel sheet of the present embodiment, in addition, the average grain size D (μm) satisfies Formula (4), and the yield elongation is 0.5% or more:

$$D < 80 - Si \times 10 \qquad ( 4 )$$

where, the content of Si in percent by mass in the chemical composition of the non-oriented electrical steel sheet is substituted for Si in Formula (4).

Fn is defined as follows.

$$Fn = 80 - Si \times 10$$

If the average grain size D (μm) is less than Fn, dislocation generation sources during deformation can be increased and the dislocation generation sources can be dispersed. In such case, dislocations will occur dispersedly and will not occur locally during deformation of the steel sheet during blanking. Consequently, entanglement of dislocations will be suppressed. Therefore, the yield elongation will easily become 0.5% or more and non-uniformity of deformation in the thickness direction during blanking can be reduced. As a result, the dimensional accuracy after blanking can be increased.

A preferable lower limit of the average grain size D is 10 μm, more preferably is 15 μm, and further preferably is 20 μm.

A preferable upper limit of the average grain size D is 75-Si×10 (μm), more preferably is 70-Si×10 (μm), and further preferably is 65-Si×10 (μm).

A preferable lower limit of the yield elongation is 0.6%, more preferably is 0.7%, further preferably is 1.0%, and further preferably is 1.5%.

Although the upper limit of the yield elongation is not particularly limited, approximately 7.0% is the upper limit.

### [Method for Measuring Average Grain Size D]

The average grain size D is determined by the following method. A cross section (L cross section) parallel to the rolling elongation direction of the non-oriented electrical steel sheet is adopted as an observation surface. The observation surface is mirror-polished, and thereafter the mirror-polished observation surface is subjected to etching using a nital solution. The etched observation surface is observed at a magnification of 100× using an optical microscope, and a photographic image of the observation field is generated. Using the photographic image, the average grain size D (μm) is determined by a method that calculates the number of grains inside a rectangular region, which will be described later, in accordance with JIS G 0551: 2013 “Steels-Micrographic determination of the apparent grain size.”

Specifically, in the L cross section, a rectangular region is drawn which is a region consisting of only recrystallized grains and excludes non-recrystallized regions and which is surrounded by line segments parallel to the sheet thickness direction and sheet surface direction (rolling elongation direction). The rectangular region is taken as the observation field. An area A of the rectangular region is set to 0.5 mm² or more. In a case where an area of 0.5 mm² or more cannot be secured with one rectangle, a plurality of rectangular regions are drawn so that a total area A of the rectangular regions is 0.5 mm² or more.

The number of grains in the rectangular region is counted. Specifically, the number of grains which exist within the rectangular region and which do not contact any of the sides of the rectangular region is expressed as N1. The number of grains which intersect with any of the four sides of the rectangular region excluding the four corners of the sides (the four vertices of the rectangle) is expressed as N2. The number of all rectangular regions which were drawn to secure an area of 0.5 mm² or more is expressed as N3. The average grain size D (μm) is calculated by Formula (I) using the total area A (mm²) of the rectangular region(s) and the number of grains N1 to N3.

$$\begin{matrix}[ Math 1 ] & \\ Average grain size D = {\{ \frac{A}{( N 1 + \frac{N 2}{2} + N 3 )} \}}^{0.5} \times 1 \; 000 & ( I )\end{matrix}$$

### [Method for Measuring Yield Elongation]

The yield elongation is determined by the following method. A tensile test specimen is taken from the non-oriented electrical steel sheet. A tensile test is carried out at normal temperature in the atmosphere in accordance with JIS Z 2241: 2011, and the yield elongation (%) is determined. A JIS No. 5 tensile test coupon is used as the tensile test specimen.

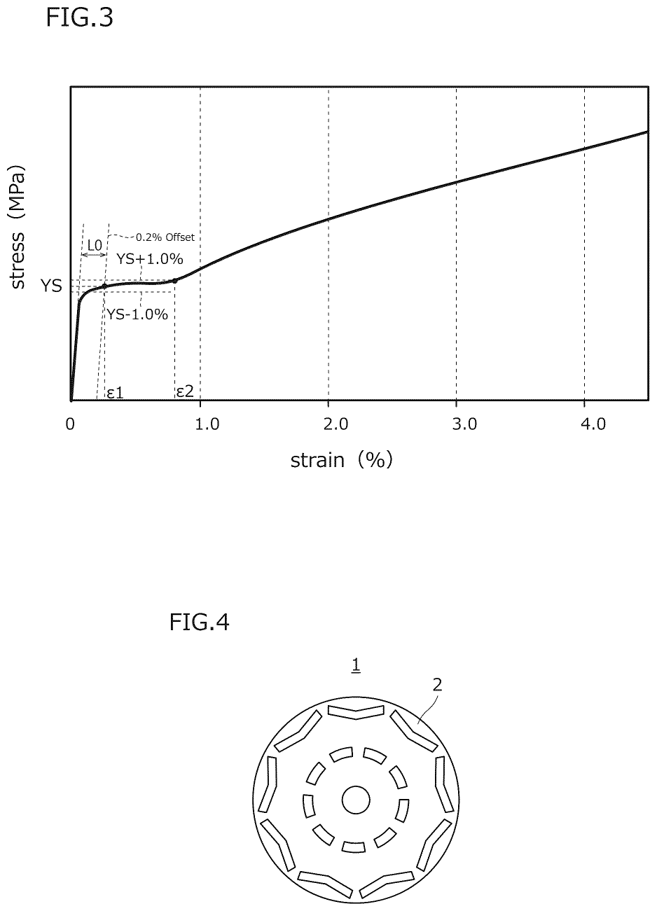

Note that, in a case where the upper yield point is not clearly visible, the yield elongation (%) is determined by the following method. Referring to FIG. 3, in a stress-strain curve obtained by the tensile test, the yield strength YS (MPa) is determined based on the method described above in the section [Work hardening amount WH evaluation test]. The strain value at the determined yield strength YS is expressed as ε1. In the stress-strain curve from the strain value ε1 onwards, a maximum strain value ε2 in a region where the stress is maintained within a range of the yield stress YS±1.0% as the strain increases is identified. The yield elongation is determined by the following formula using ε1 and ε2.

$$Yield elongation ( \% ) = ε2 ‐ ε 1$$

### [Regarding Advantageous Effects of Non-Oriented Electrical Steel Sheet of Present Embodiment]

The non-oriented electrical steel sheet of the present embodiment satisfies feature 1 to feature 5. Therefore, in the non-oriented electrical steel sheet of the present embodiment, even though high strength and sufficient magnetic properties are obtained, excellent dimensional accuracy after blanking is obtained.

### [Method for Producing Non-Oriented Electrical Steel Sheet]

One example of a method for producing the non-oriented electrical steel sheet of the present embodiment will now be described. The method for producing the non-oriented electrical steel sheet of the present embodiment includes the following processes.
(Process 1) Hot rolling process
(Process 2) Hot-rolled sheet annealing process
(Process 3) Cold rolling process
(Process 4) Final annealing process

Among the above process 1 to process 4, process 2 is an optional process. That is, process 2 does not have to be performed. Each process will be described hereunder.

### [(Process 1) Hot Rolling Process]

In the hot rolling process, a slab is subjected to hot rolling to produce a hot-rolled steel sheet. The slab is produced by a well-known method. For example, the slab is produced by a continuous casting process.

The prepared slab is subjected to hot rolling. The various conditions in the hot rolling are not particularly limited. The slab heating temperature is, for example, 1100 to 1200° C. The rolling finishing temperature is, for example, 800 to 1100° C. The coiling temperature is, for example, 700 to 800° C. A hot-rolled steel sheet is produced by the above process.

### [(Process 2) Hot-Rolled Sheet Annealing Process]

The hot-rolled sheet annealing process is an optional process. That is, the hot-rolled sheet annealing process may be performed, or need not be performed. When performed, in the hot-rolled sheet annealing process, annealing of the hot-rolled steel sheet is performed. The hot-rolled sheet annealing may be box annealing or may be continuous annealing. The annealing conditions in the hot-rolled sheet annealing process are not particularly limited. In the case of performing box annealing, the annealing temperature is, for example, 750° C. to 850° C., and the holding time at the annealing temperature is, for example, one hour to 30 hours. In the case of performing continuous annealing, the annealing temperature is, for example, 900° C. to 1000° C., and the holding time at the annealing temperature is, for example, 1 second to 100 seconds. Note that, as necessary, a well-known pickling treatment may be performed on the hot-rolled steel sheet before performing annealing in the hot-rolled sheet annealing process, and/or on the hot-rolled steel sheet after annealing is performed.

### [(Process 3) Cold Rolling Process]

In the cold rolling process, the hot-rolled steel sheet produced in the hot rolling process or the hot-rolled steel sheet after the hot-rolled sheet annealing process is subjected to cold rolling to produce a cold-rolled steel sheet. The cold rolling may be performed only one time or may be performed multiple times. In the case of performing cold rolling multiple times, intermediate annealing may be performed at a timing after one cold rolling operation is performed and before the next cold rolling operation is performed.

### [(Process 4) Final Annealing Process]

The cold-rolled steel sheet produced by performing the cold rolling process is subjected to final annealing in a final annealing furnace. In the final annealing, the cold rolled steel sheet finished to the final sheet thickness is annealed to cause recrystallization and grain growth. In the final annealing process, the following condition 1 to condition 5 are satisfied.

### (Condition 1)

Anneal at a maximum attainment temperature T1 (° C.) of 950° C. or less.

### (Condition 2)

A tension TE applied to the cold-rolled steel sheet at the maximum attainment temperature T1 (° C.) is to be 2.0 to 10.0 MPa.

### (Condition 3)

A residence time t0 (seconds) from an annealing temperature T1 to 700° C. in a heating zone, a soaking zone, and a cooling zone of the final annealing furnace, and a residence time t1 (seconds) from 700 to 500° C. in the cooling zone are to be set to satisfy Formula (A) and Formula (B).

$$t 1 ‐ t 0 > 0 \qquad ( A )$$

$$t 1 / t 0 \leq 3. \qquad ( B )$$

### (Condition 4)

In addition, at one location or more selected from the heating zone, the soaking zone, and the cooling zone in a temperature range of 500° C. or more in a furnace atmosphere of the final annealing furnace, a ratio of a water vapor partial pressure P_{H20} (atm) to a hydrogen partial pressure P_{H2} (atm) is to be made higher than 0.05, or an oxygen concentration is to be made higher than 0.010% percent by volume.

### (Condition 5)

A temperature gradient CG in a longitudinal direction of the cold-rolled steel sheet in a cooling process is to be 20° C./m or less.

Hereunder, condition 1 to condition 5 are described.

### [(Condition 1) Regarding Maximum Attainment Temperature T1]

The maximum attainment temperature T1 is to be 950° C. or less. If the maximum attainment temperature T1 is more than 950° C., solubilization of carbides and nitrides will occur in the steel sheet. As a result, the work hardening amount WH defined by Formula (3) will become 15 MPa or more. Therefore, the maximum attainment temperature T1 is 950° C. or less. It suffices that the lower limit of the maximum attainment temperature T1 is a well-known temperature. The lower limit of the maximum attainment temperature T1 is, for example, 800° C.

### [(Condition 2) Regarding Tension TE at Maximum Attainment Temperature T1]

The tension TE applied to the cold-rolled steel sheet at the maximum attainment temperature T1 is to be 2.0 to 10.0 MPa. Specifically, the tension TE is to be applied in the rolling elongation direction (longitudinal direction) of the cold-rolled steel sheet.

If the tension TE is less than 2.0 MPa, dislocation generation sources will not be sufficiently obtained in the steel sheet. In such case, even if the non-oriented electrical steel sheet satisfies Formula (4), the yield elongation will be less than 0.5%.

On the other hand, if the tension TE is more than 10.0 MPa, residual strain will occur in the steel sheet. In such case, the work hardening amount WH will be 15 MPa or more.

[(Condition 3) Regarding Residence Time t0 and t1]

In the final annealing, the residence time t0 (seconds) from the annealing temperature T1 to 700° C. in a heating zone, a soaking zone, and a cooling zone of the final annealing furnace, and a residence time t1 (seconds) from 700 to 500° C. in the cooling zone are to be set to satisfy Formula (A) and Formula (B):

$$t 1 ‐ t 0 > 0 \qquad ( A )$$

$$t 1 / t 0 \leq 3. \qquad ( B )$$

where, the residence time t0 includes, in the heating zone, soaking zone, and cooling zone, the time taken to arrive at the maximum attainment temperature T1 from 700° C. in the heating process, the holding time at the maximum attainment temperature T1, and the time taken to arrive at 700° C. from the maximum attainment temperature T1 in the cooling process. The residence time t1 corresponds to the time period in the range from 700 to 500° C. in the cooling zone, and does not include the time taken to arrive at 700° C. from 500° C. in the heating process (heating zone).

In the temperature range from the annealing temperature T1 to 700° C., carbides and nitrides easily dissolve, and dissolved C and dissolved N easily form. On the other hand, the temperature range from 700 to 500° C. is a temperature range in which carbides, carbo-nitrides, and nitrides easily form. Dissolved C and dissolved N fix to dislocations, and inhibit movement of the dislocations. If dislocations whose movement is inhibited increase, entanglement of dislocations will increase. Therefore, in the non-oriented electrical steel sheet of the present embodiment, dissolved C and dissolved N are reduced as much as possible.

FA is defined as follows.

$$FA = t 1 ‐ t 0$$

FA corresponds to the left-hand side of Formula (A). If FA is greater than 0, in other words, if the residence time t1 is longer than the residence time t0, while suppressing solubilization of carbides and nitrides which were formed before the final annealing, carbon and nitrogen which have dissolved can be fixed again as carbides, carbo-nitrides, and nitrides. Therefore, dissolved C and dissolved N in the steel sheet can be reduced. As a result, the work hardening amount WH can be made less than 15 MPa.

FB is defined as follows.

$$FB = t 1 / t 0$$

FB corresponds to the left-hand side of Formula (B). If FB is more than 3.0, dissolved C and dissolved N remaining in the steel sheet will fix to dislocations and will not precipitate as precipitates. In such case, because it will become easy for dislocations to pile-up, the work hardening amount WH will increase. If FB is 3.0 or less, the work hardening amount WH can be sufficiently suppressed.

### [(Condition 4) Regarding Oxygen Potential]

In the final annealing, in addition, at one location or more selected from the heating zone, the soaking zone, and the cooling zone in a temperature range of 500° C. or more in the furnace atmosphere of the final annealing furnace, a ratio of a water vapor partial pressure P_{H20} (atm) to a hydrogen partial pressure P_{H2} (atm) is to be made higher than 0.05, or an oxygen concentration is to be made higher than 0.010%.

The ratio of the water vapor partial pressure P_{H20} (atm) to the hydrogen partial pressure P_{H2} (atm) in the furnace atmosphere of the final annealing furnace is defined as the oxygen potential. At one location or more selected from the heating zone, the soaking zone, and the cooling zone in a temperature range of 500° C. or more in the furnace atmosphere of the final annealing furnace, if the oxygen potential is higher than 0.05 or if the oxygen concentration is higher than 0.010%, decarburization will be promoted in the steel sheet during the final annealing. In such case, dissolved C in the steel sheet can be sufficiently reduced. As a result, the work hardening amount WH can be made less than 15 MPa.

### [(Feature 5) Regarding Temperature Gradient CG in Longitudinal Direction of Cold-Rolled Steel Sheet in Cooling Process]

In the cooling process, a temperature gradient in the longitudinal direction (rolling elongation direction) of the cold-rolled steel sheet until arriving at 500° C. from the maximum attainment temperature T1 is defined as “CG (° C./m)”. The temperature gradient CG is determined based on the distance the steel sheet travels in the time period until the temperature of the cold-rolled steel sheet arrives at 500° C. from the maximum attainment temperature T1, and a temperature difference calculated by subtracting 500° C. from the maximum attainment temperature T1.

If the temperature gradient CG in the cooling process is more than 20° C./m, residual strain will occur in the steel sheet due to thermal strain. In such case, the work hardening amount WH will be 15 MPa or more. Therefore, the temperature gradient CG is to be 20° C./m or less.

### [Other Process]

In the production method described above, a coating process may be performed after the final annealing process. In the coating process, an insulating coating is applied to the surface of the non-oriented electrical steel sheet after the final annealing. The type of insulating coating is not particularly limited. The insulating coating may be composed of organic components or inorganic components.

The non-oriented electrical steel sheet of the present embodiment can be produced by the production method described above. Note that, a method for producing the non-oriented electrical steel sheet of the present embodiment is not particularly limited as long as the non-oriented electrical steel sheet satisfies feature 1 to feature 5.

### [Regarding Rotor Core]

The rotor core of the present embodiment is produced using the non-oriented electrical steel sheet of the present embodiment as a starting material.

FIG. 4 is a plan view illustrating one example of a rotor core 1. Referring to FIG. 4, the rotor core 1 includes a plurality of rotor core starting materials 2. The rotor core starting material 2 is a sheet shape. More specifically, the rotor core starting material 2 is a disk shape. The rotor core 1 is constituted by a plurality of the rotor core starting materials 2 that are stacked together.

The shape of the rotor core starting material 2 is not particularly limited as long as it is a sheet shape. In FIG. 4, as one example, a rotor core starting material 2 of a permanent magnet synchronous motor is illustrated. However, as long as the rotor core starting material 2 is a sheet shape, the rotor core starting material 2 may have a different shape to the shape illustrated in FIG. 4. For example, in a case where the motor is a reluctance motor, the rotor core starting material 2 may be a sheet shape having a plurality of salient poles, or may be a sheet shape having a plurality of through-holes that serve as flux barriers. Further, in a case where the motor is an induction motor, the rotor core starting material 2 may have a plurality of through-holes in which induced current paths composed of copper or aluminum die casting or the like are provided.

As described above, the rotor core starting material 2 is a blanked product that is produced by cutting out the non-oriented electrical steel sheet of the present embodiment. Therefore, the rotor core starting material 2 satisfies the aforementioned feature 1 to feature 5.

Specifically, the rotor core starting material 2 consists of, in mass %, Si: 3.1 to 4.5%, C: 0.0025% or less, N: 0.0025% or less, O: 0.0400% or less, P: 0.100% or less, S: 0.0050% or less, Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, Ce: 0 to 0.0100%, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%, with the balance being Fe and impurities, and satisfies Formula (1) and Formula (2):

$$Si / 28 + Ti / 48 + Nb / 93 + V / 51 + Zr / 91 + Mo / 96 + Cr / 52 > C / 12 \times 750 \qquad ( 1 )$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

In the rotor core starting material 2, in addition, a tensile strength TS is higher than 570 MPa.

In the rotor core starting material 2, furthermore, when a stress at 2.0% strain is expressed as Y_{2.0} (MPa) and a yield stress is expressed as YS (MPa), a work hardening amount WH defined by Formula (3) is less than 15 MPa.

$$WH = {Y}_{2.} ‐ YS \qquad ( 3 )$$

In the rotor core starting material 2, in addition, an average grain size D (μm) satisfies Formula (4), and a yield elongation is 0.5% or more:

$$D < 80 ‐ Si \times 10 \qquad ( 4 )$$

where, a content of a corresponding element in percent by mass is substituted for a symbol of an element in Formula (4), and if the corresponding element is not contained, “0” is substituted for the symbol of the corresponding element.

### [Regarding Stator Core]

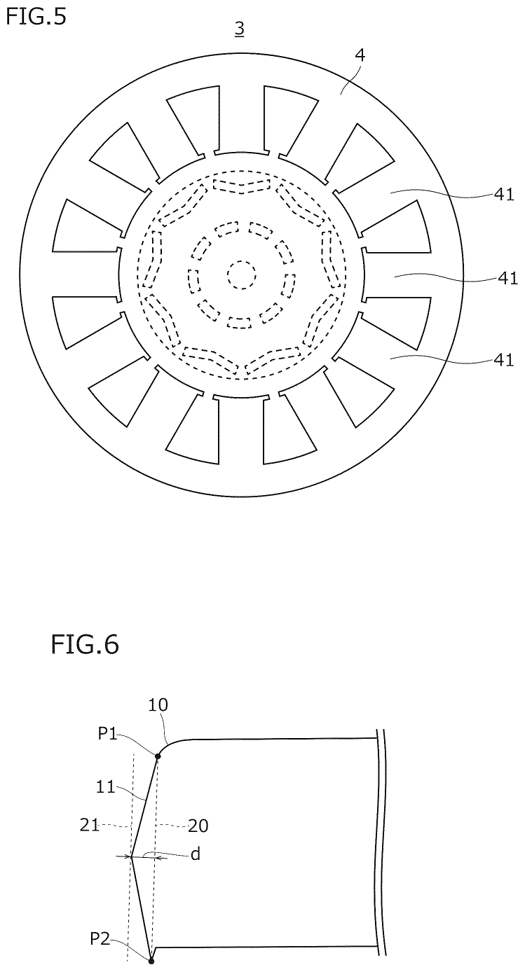

Note that, a stator core may be produced using the non-oriented electrical steel sheet of the present embodiment as a starting material. FIG. 5 is a plan view of a stator core 3. Referring to FIG. 5, the stator core 3 includes a plurality of stator core starting materials 4. The stator core starting material 4 is an annular sheet shape. The stator core 3 is constituted by a plurality of the stator core starting materials 4 that are stacked together.

The stator core starting material 4 includes a plurality of teeth portions 41. The plurality of teeth portions 41 are arranged with a gap between the respective teeth portions 41 in the circumferential direction of the stator core starting material 4. Each of the teeth portions 41 extends in the radial direction of the stator core starting material 4.

The stator core starting material 4 is produced by cutting out the non-oriented electrical steel sheet of the present embodiment, and thereafter performing strain relief annealing. Therefore, the stator core starting material 4 satisfies the aforementioned feature 1 and feature 2.

Specifically, the stator core starting material 4 consists of, in mass %, Si: 3.1 to 4.5%, C: 0.0025% or less, N: 0.0025% or less, O: 0.0400% or less, P: 0.100% or less, S: 0.0050% or less, Ti: 0.0100% or less, Mn: 2.0% or less, Al: 1.500% or less, Zr: 0 to 0.0100%, Nb: 0 to 0.0100%, V: 0 to 0.0100%, Mo: 0 to 0.100%, Cr: 0 to 2.000%, La: 0 to 0.0100%, Ce: 0 to 0.0100%, B: 0 to 0.0010%, Zn: 0 to 0.0050%, Ga: 0 to 0.0050%, Ge: 0 to 0.0050%, As: 0 to 0.0100%, Ni: 0 to 0.500%, Cu: 0 to 0.500%, Sn: 0 to 0.200%, Sb: 0 to 0.100%, Ca: 0 to 0.0050%, Nd: 0 to 0.0010%, and Mg: 0 to 0.0030%, with the balance being Fe and impurities, and satisfies Formula (1) and Formula (2):

$$Si / 28 + Ti / 48 + Nb / 93 + V / 51 + Zr / 91 + Mo / 96 + Cr / 52 > C / 12 \times 750 \qquad ( 1 )$$

$$Si / 28 + Al / 27 + Ti / 48 + Zr / 91 + La / 139 + Ce / 140 > N / 14 \times 1000 \qquad ( 2 )$$

where, a content of a corresponding element in percent by mass is substituted for each symbol of an element in Formula (1) and Formula (2), and if a corresponding element is not contained, “0” is substituted for the symbol of the corresponding element.

### [Method for Measuring Chemical Composition in Rotor Core Starting Material 2 and Stator Core Starting Material 4]

The chemical composition of the rotor core starting material 2 and the stator core starting material 4 can be measured based on the method described above in the section [Method for measuring chemical composition of non-oriented electrical steel sheet]. Specifically, a drill is used to collect a machined chip from the rotor core starting material 2 or the stator core starting material 4. The collected machined chip is dissolved in acid to obtain a liquid solution. The liquid solution is subjected to ICP-AES to perform elemental analysis of the chemical composition. The content of C and the content of S are determined by a well-known high-frequency combustion method (combustion-infrared absorption method). The content of N is determined using a well-known inert gas fusion-thermal conductivity method. The content of O is determined using a well-known inert gas fusion-infrared absorption method.

### [Method for Measuring Stress-Strain Curve of Rotor Core Starting Material 2]

The tensile strength TS of the rotor core starting material 2 is measured by the following method. A JIS No. 5 tensile test coupon defined in JIS Z 2241 (2011) is taken from the rotor core starting material 2. In a case where a JIS No. 5 tensile test coupon cannot be taken because the size of the rotor core starting material 2 is small, a reduced-scale test specimen of a JIS No. 5 tensile test coupon is taken from the rotor core starting material 2.

The taken tensile test specimen is used to carry out a tensile test at normal temperature in the atmosphere in accordance with JIS Z 2241: 2011 to obtain a stress-strain curve. The tensile strength TS (MPa) is determined from the obtained stress-strain curve. Note that, in the case of performing the tensile test using a reduced-scale test specimen, the test is to be performed based on the strain rate specified in Annex JB of the aforementioned standard.

### [Test to Evaluate Work Hardening Amount WH of Rotor Core Starting Material 2]

The work hardening amount WH of the rotor core starting material 2 is determined by the method described above in the section [Work hardening amount WH evaluation test]. At such time, the stress-strain curve obtained in the aforementioned [Method for measuring stress-strain curve of rotor core starting material 2] is used as the stress-strain curve.

### [Method for Measuring Average Grain Size D of Rotor Core Starting Material 2]

The average grain size D of the rotor core starting material 2 is determined by the method described above in the section [Method for measuring average grain size D]. Note that, in the rotor core starting material 2, a cross section (L cross section) parallel to the rolling elongation direction is adopted as an observation surface.

### [Method for Measuring Yield Elongation of Rotor Core Starting Material 2]

The yield elongation of the rotor core starting material 2 is determined by the following method. Specifically, a JIS No. 5 tensile test coupon is taken from the rotor core starting material 2. A tensile test is carried out at normal temperature in the atmosphere in accordance with JIS Z 2241: 2011 to determine the yield elongation (%). Note that, in a case where a JIS No. 5 tensile test coupon cannot be taken because the size of the rotor core starting material 2 is small, a reduced-scale test specimen of a JIS No. 5 tensile test coupon is taken from the rotor core starting material 2. In the case of performing the tensile test using a reduced-scale test specimen, the test is to be performed based on the strain rate specified in Annex JB of the aforementioned standard.

Note that, in a case where the upper yield point does not clearly appear, the yield elongation (%) is determined by the following method. Referring to FIG. 3, in the stress-strain curve obtained by the tensile test, the yield strength YS (MPa) is determined based on the method described above in the section [Test to evaluate work hardening amount WH of rotor core starting material 2]. The strain value at the determined yield strength YS is expressed as ε1. In the stress-strain curve from the strain value ε1 onwards, a maximum strain value ε2 in a region where the stress is maintained within a range of the yield stress YS±1.0% as the strain increases is identified. The yield elongation is determined by the following formula using ε1 and ε2.

$$Yield elongation ( \% ) = ε2 ‐ ε 1$$

### [Method for Producing Rotor Core 1]

The rotor core 1 is produced by the following method.

Rotor core starting materials 2 are produced from the non-oriented electrical steel sheet of the present embodiment by blanking. Specifically, the rotor core starting materials 2 are cut out by blanking. The blanked rotor core starting materials 2 are stacked to produce the rotor core 1.

### [Regarding Motor]

The motor of the present embodiment is equipped with the rotor core 1 described above. The motor is also equipped with a well-known stator core. Because the motor of the present embodiment is equipped with the rotor core of the present embodiment, high strength and sufficient magnetic properties are obtained in the rotor core.

Note that, the stator core 3 described above may be adopted as the stator core included in the motor core. The stator core 3 is produced by the following method. The stator core starting material 4 is produced by blanking using the non-oriented electrical steel sheet of the present embodiment as a starting material. A plurality of the stator core starting materials 4 are stacked to produce the stator core 3.

The dimensional accuracy of the stator core starting material 4 produced by blanking using the non-oriented electrical steel sheet of the present embodiment as a starting material is high. Therefore, the stator core 3 is superior in terms of dimensional accuracy as compared to a stator core produced using a conventional non-oriented electrical steel sheet having a tensile strength of more than 570 MPa as a starting material. In the case of producing the stator core 3 using the non-oriented electrical steel sheet of the present embodiment as a starting material, after the stator core starting materials 4 are stacked, strain relief annealing is performed. Thus, the motor that incorporates the stator core 3 will have higher efficiency.

### Example 1

Non-oriented electrical steel sheets having the chemical compositions shown in Table 1 (Table 1A to Table 1C) were produced by the following method.

TABLE 1A

| Test | Chemical Composition (unit is mass %; balance is Fe and impurities) | | | | | | | | |
|---|---|---|---|---|---|---|---|---|---|
| Number | Si | C | N | O | P | S | Ti | Mn | Al |
| 1 | 3.3 | 0.0018 | 0.0013 | 0.0155 | 0.011 | 0.0012 | 0.0011 | 1.1 | 0.700 |
| 2 | 3.5 | 0.0017 | 0.0018 | 0.0210 | 0.007 | 0.0008 | 0.0013 | 0.6 | 0.300 |
| 3 | 4.2 | 0.0011 | 0.0011 | 0.0131 | 0.011 | 0.0003 | 0.0052 | 0.5 | 0.004 |
| 4 | 3.6 | 0.0010 | 0.0012 | 0.0171 | 0.033 | 0.0027 | 0.0016 | 0.3 | 0.300 |
| 5 | 3.8 | 0.0018 | 0.0017 | 0.0022 | 0.010 | 0.0022 | 0.0013 | 0.2 | 0.355 |
| 6 | 3.4 | 0.0017 | 0.0018 | 0.0136 | 0.034 | 0.0047 | 0.0021 | 0.4 | 0.409 |
| 7 | 3.9 | 0.0022 | 0.0010 | 0.0367 | 0.011 | 0.0009 | 0.0017 | 0.2 | 0.848 |
| 8 | 4.0 | 0.0024 | 0.0021 | 0.0091 | 0.007 | 0.0039 | 0.0008 | 0.5 | 0.246 |
| 9 | 3.3 | 0.0012 | 0.0012 | 0.0194 | 0.061 | 0.0012 | 0.0016 | 0.6 | 1.450 |
| 10 | 3.5 | 0.0011 | 0.0018 | 0.0268 | 0.033 | 0.0013 | 0.0013 | 0.8 | 0.393 |
| 11 | 3.6 | 0.0010 | 0.0012 | 0.0250 | 0.015 | 0.0007 | 0.0014 | 0.2 | 0.307 |
| 12 | 4.1 | 0.0011 | 0.0010 | 0.0045 | 0.007 | 0.0007 | 0.0011 | 0.2 | 0.402 |
| 13 | 4.3 | 0.0010 | 0.0019 | 0.0143 | 0.039 | 0.0027 | 0.0009 | 0.5 | 0.203 |
| 14 | 3.6 | 0.0017 | 0.0013 | 0.0065 | 0.050 | 0.0005 | 0.0013 | 0.4 | 0.577 |
| 15 | 3.3 | 0.0019 | 0.0017 | 0.0055 | 0.026 | 0.0014 | 0.0021 | 1.1 | 0.307 |
| 16 | 3.5 | 0.0015 | 0.0012 | 0.0134 | 0.007 | 0.0017 | 0.0023 | 0.2 | 0.724 |
| 17 | 3.2 | 0.0018 | 0.0014 | 0.0068 | 0.010 | 0.0007 | 0.0011 | 0.4 | 1.113 |
| 18 | 3.4 | 0.0015 | 0.0022 | 0.0243 | 0.016 | 0.0029 | 0.0016 | 0.3 | 1.239 |
| 19 | 3.8 | 0.0011 | 0.0018 | 0.0181 | 0.043 | 0.0008 | 0.0025 | 0.2 | 0.310 |
| 20 | 3.6 | 0.0019 | 0.0013 | 0.0152 | 0.007 | 0.0037 | 0.0017 | 0.8 | 0.681 |
| 21 | 3.3 | 0.0016 | 0.0019 | 0.0110 | 0.013 | 0.0005 | 0.0011 | 1.3 | 0.551 |
| 22 | 3.5 | 0.0017 | 0.0021 | 0.0348 | 0.011 | 0.0014 | 0.0013 | 0.3 | 0.939 |
| 23 | 3.2 | 0.0018 | 0.0015 | 0.0083 | 0.012 | 0.0007 | 0.0014 | 0.6 | 0.827 |
| 24 | 3.4 | 0.0016 | 0.0016 | 0.0107 | 0.026 | 0.0021 | 0.0011 | 0.6 | 0.517 |
| 25 | 3.6 | 0.0019 | 0.0019 | 0.0208 | 0.013 | 0.0023 | 0.0016 | 0.4 | 0.447 |
| 26 | 3.3 | 0.0011 | 0.0017 | 0.0301 | 0.046 | 0.0013 | 0.0023 | 1.1 | 0.483 |
| 27 | 3.5 | 0.0017 | 0.0018 | 0.0200 | 0.011 | 0.0015 | 0.0006 | 0.4 | 0.570 |
| 28 | 3.8 | 0.0020 | 0.0021 | 0.0048 | 0.017 | 0.0011 | 0.0014 | 0.4 | 0.446 |
| 29 | 3.3 | 0.0017 | 0.0018 | 0.0357 | 0.072 | 0.0006 | 0.0020 | 0.7 | 0.639 |
| 30 | 3.6 | 0.0018 | 0.0022 | 0.0051 | 0.017 | 0.0016 | 0.0018 | 0.7 | 1.180 |
| 31 | 3.2 | 0.0019 | 0.0018 | 0.0077 | 0.083 | 0.0029 | 0.0007 | 1.6 | 0.410 |
| 32 | 3.7 | 0.0024 | 0.0010 | 0.0184 | 0.012 | 0.0013 | 0.0014 | 0.4 | 0.308 |
| 33 | 3.9 | 0.0012 | 0.0024 | 0.0301 | 0.014 | 0.0026 | 0.0006 | 1.2 | 0.314 |
| 34 | 3.8 | 0.0011 | 0.0023 | 0.0143 | 0.022 | 0.0003 | 0.0007 | 1.5 | 0.287 |
| 35 | 3.0 | 0.0014 | 0.0019 | 0.0360 | 0.008 | 0.0015 | 0.0022 | 0.3 | 0.789 |
| 36 | 2.9 | 0.0012 | 0.0017 | 0.0049 | 0.011 | 0.0020 | 0.0005 | 0.2 | 0.521 |
| 37 | 3.0 | 0.0016 | 0.0016 | 0.0025 | 0.013 | 0.0018 | 0.0013 | 1.5 | 1.214 |
| 38 | 3.0 | 0.0013 | 0.0017 | 0.0021 | 0.011 | 0.0014 | 0.0008 | 1.2 | 1.113 |
| 39 | 3.7 | 0.0021 | 0.0020 | 0.0084 | 0.014 | 0.0007 | 0.0021 | 1.1 | 0.433 |
| 40 | 3.9 | 0.0021 | 0.0017 | 0.0163 | 0.013 | 0.0006 | 0.0010 | 0.2 | 0.885 |
| 41 | 3.3 | 0.0015 | 0.0016 | 0.0024 | 0.010 | 0.0011 | 0.0008 | 0.5 | 0.311 |
| 42 | 3.5 | 0.0017 | 0.0015 | 0.0031 | 0.009 | 0.0013 | 0.0016 | 0.4 | 0.231 |
| 43 | 3.3 | 0.0018 | 0.0013 | 0.0022 | 0.013 | 0.0013 | 0.0011 | 0.5 | 0.224 |
| 44 | 3.4 | 0.0015 | 0.0017 | 0.0026 | 0.014 | 0.0015 | 0.0013 | 0.3 | 0.343 |
| 45 | 4.0 | 0.0022 | 0.0019 | 0.0381 | 0.011 | 0.0034 | 0.0006 | 0.2 | 0.301 |
| 46 | 3.6 | 0.0020 | 0.0016 | 0.0248 | 0.021 | 0.0004 | 0.0009 | 0.2 | 0.398 |
| 47 | 3.4 | 0.0017 | 0.0018 | 0.0023 | 0.011 | 0.0011 | 0.0017 | 0.5 | 0.413 |
| 48 | 3.6 | 0.0016 | 0.0016 | 0.0019 | 0.009 | 0.0016 | 0.0019 | 0.4 | 0.526 |
| 49 | 3.4 | 0.0018 | 0.0019 | 0.0192 | 0.016 | 0.0007 | 0.0006 | 0.7 | 0.462 |
| 50 | 3.8 | 0.0016 | 0.0020 | 0.0283 | 0.015 | 0.0007 | 0.0007 | 1.4 | 0.324 |
| 51 | 3.3 | 0.0017 | 0.0017 | 0.0016 | 0.001 | 0.0009 | 0.0013 | 0.3 | 0.379 |
| 52 | 3.5 | 0.0019 | 0.0018 | 0.0027 | 0.014 | 0.0007 | 0.0007 | 0.5 | 0.351 |

TABLE 1B

| Test | Chemical Composition (unit is mass %; balance is Fe and impurities) | | | | | | | | | |
|---|---|---|---|---|---|---|---|---|---|---|
| Number | Zr | Nb | V | Mo | Cr | La | Ce | B | Zn | Ga |
| 1 | — | — | — | — | 0.023 | — | — | — | — | — |
| 2 | — | — | — | 0.020 | 0.041 | — | — | — | 0.0001 | — |
| 3 | 0.0092 | 0.0014 | — | 0.010 | 0.023 | 0.0054 | 0.0056 | — | — | — |
| 4 | 0.0095 | — | — | — | — | — | — | — | — | — |
| 5 | — | 0.0021 | — | — | — | — | — | — | — | — |
| 6 | — | — | 0.0023 | — | — | — | — | — | — | — |
| 7 | — | — | — | 0.084 | — | — | — | — | — | — |
| 8 | — | — | — | — | 1.433 | — | — | — | — | — |
| 9 | — | — | — | — | — | — | — | — | — | — |
| 10 | — | — | — | — | — | 0.0073 | — | — | — | — |
| 11 | — | — | — | — | — | — | 0.0064 | — | — | — |
| 12 | — | — | — | — | — | — | — | 0.0007 | — | — |
| 13 | — | — | — | — | — | — | — | — | — | — |
| 14 | — | — | — | — | — | — | — | — | — | — |
| 15 | — | — | — | — | 0.052 | — | — | — | — | — |
| 16 | — | — | — | — | — | — | — | — | — | — |
| 17 | — | — | — | 0.013 | — | — | — | — | 0.0016 | — |
| 18 | — | — | — | — | — | — | — | — | — | 0.0032 |
| 19 | — | — | — | — | — | — | — | — | — | — |
| 20 | — | — | — | — | — | — | — | — | — | — |
| 21 | — | — | — | — | — | — | — | — | — | — |
| 22 | — | — | — | — | — | — | — | — | — | — |
| 23 | — | — | — | — | — | — | — | — | — | — |
| 24 | 0.0013 | — | — | — | 0.031 | — | — | 0.0002 | — | — |
| 25 | — | — | — | — | — | 0.0023 | 0.0021 | — | 0.0003 | 0.0013 |
| 26 | 0.0034 | 0.0014 | 0.0011 | 0.015 | 0.043 | — | 0.0034 | — | — | — |
| 27 | — | — | — | — | — | — | — | — | — | — |
| 28 | 0.0032 | 0.0013 | — | 0.024 | 0.130 | — | — | — | — | — |
| 29 | — | — | — | 0.013 | 0.032 | — | — | 0.0002 | — | — |
| 30 | — | — | — | — | — | — | — | — | 0.0007 | 0.0005 |
| 31 | — | — | — | — | — | — | — | — | — | — |
| 32 | — | — | — | — | — | — | — | — | — | — |
| 33 | — | — | — | — | — | — | — | — | — | — |
| 34 | — | — | — | — | — | — | — | — | — | — |
| 35 | — | — | — | — | — | — | — | — | — | — |
| 36 | 0.0013 | — | — | 0.012 | 0.037 | — | — | — | — | 0.0014 |
| 37 | — | — | — | — | — | — | — | — | — | — |
| 38 | — | — | — | 0.011 | 0.023 | — | — | — | — | — |
| 39 | — | — | — | — | — | — | — | — | — | — |
| 40 | — | — | — | — | — | 0.0026 | 0.0024 | — | — | — |
| 41 | — | — | — | 0.005 | 0.036 | — | — | — | — | — |
| 42 | — | — | — | — | 0.036 | — | — | — | — | — |
| 43 | — | — | — | 0.007 | — | — | — | — | — | — |
| 44 | — | — | — | 0.011 | 0.031 | — | — | — | — | — |
| 45 | — | — | — | — | — | — | — | — | — | — |
| 46 | — | 0.0011 | — | 0.012 | — | — | — | — | 0.0008 | — |
| 47 | — | — | — | — | — | — | — | — | — | — |
| 48 | — | — | — | — | 0.041 | — | — | — | — | — |
| 49 | — | — | — | — | — | — | — | — | — | — |
| 50 | — | — | 0.0013 | — | — | — | — | 0.0005 | — | 0.0011 |
| 51 | — | — | — | 0.007 | 0.038 | — | — | — | — | — |
| 52 | — | — | — | — | 0.029 | — | — | — | — | — |

TABLE 1C

| | Chemical Composition (unit is mass %; balance is Fe and impurities) | | | | | | | | | | |
|---|---|---|---|---|---|---|---|---|---|---|---|
| Test | | | | | | | | | | Formula | Formula |
| Number | Ge | As | Ni | Cu | Sn | Sb | Ca | Nd | Mg | (1) | (2) |
| 1 | — | — | — | — | 0.011 | — | — | — | — | T | T |
| 2 | — | 0.0030 | 0.020 | 0.060 | 0.007 | — | 0.0005 | — | 0.0008 | T | T |
| 3 | — | 0.0010 | 0.020 | 0.060 | 0.013 | — | 0.0005 | — | 0.0006 | T | T |
| 4 | — | — | — | — | — | — | — | — | — | T | T |
| 5 | — | — | — | — | — | — | — | — | — | T | T |
| 6 | — | — | — | — | — | — | — | — | — | T | T |
| 7 | — | — | — | — | — | — | — | — | — | T | T |
| 8 | — | — | — | — | — | — | — | — | — | T | T |
| 9 | — | — | — | — | — | — | — | — | — | T | T |
| 10 | — | — | — | — | — | — | — | — | — | T | T |
| 11 | — | — | — | — | — | — | — | — | — | T | T |
| 12 | — | — | — | — | — | — | — | — | — | T | T |
| 13 | — | — | — | — | — | — | — | — | 0.0024 | T | T |
| 14 | — | — | — | — | — | — | 0.0035 | — | — | T | T |
| 15 | — | — | 0.236 | — | — | — | — | — | — | T | T |
| 16 | — | — | — | 0.142 | — | — | — | — | — | T | T |
| 17 | — | — | — | — | — | — | — | — | — | T | T |
| 18 | — | — | — | — | — | — | — | — | — | T | T |
| 19 | 0.0035 | — | — | — | — | — | — | — | — | T | T |
| 20 | — | 0.0059 | — | — | — | — | — | — | — | T | T |
| 21 | — | — | — | — | 0.110 | — | — | — | — | T | T |
| 22 | — | — | — | — | — | 0.063 | — | — | — | T | T |
| 23 | — | — | — | — | — | — | — | 0.0006 | — | T | T |
| 24 | — | 0.0023 | — | 0.031 | 0.011 | — | — | — | — | T | T |
| 25 | 0.0011 | 0.0024 | 0.031 | 0.043 | 0.021 | — | 0.0011 | 0.0008 | 0.0005 | T | T |
| 26 | — | — | — | — | — | — | — | 0.0005 | — | T | T |
| 27 | — | — | — | — | — | 0.013 | — | — | — | T | T |
| 28 | — | — | — | — | — | — | — | — | — | T | T |
| 29 | — | 0.0027 | — | 0.036 | 0.013 | — | 0.0023 | — | — | T | T |
| 30 | — | — | 0.026 | — | — | — | — | — | 0.0008 | T | T |
| 31 | — | — | — | — | — | — | — | — | — | F | T |
| 32 | — | — | — | — | — | — | — | — | — | F | T |
| 33 | — | — | — | — | — | — | — | — | — | T | F |
| 34 | — | — | — | — | — | — | — | — | — | T | F |
| 35 | — | — | — | — | — | — | — | — | — | T | T |
| 36 | — | 0.0026 | — | — | 0.014 | — | — | — | — | T | T |
| 37 | — | — | — | — | — | — | — | — | — | T | T |
| 38 | — | — | 0.027 | 0.043 | 0.012 | — | 0.0014 | — | — | T | T |
| 39 | — | — | — | — | — | — | — | — | — | T | T |
| 40 | — | — | — | — | 0.023 | — | 0.0013 | — | — | T | T |
| 41 | — | — | — | 0.036 | — | — | — | — | — | T | T |
| 42 | — | 0.0026 | — | — | 0.021 | — | — | — | — | T | T |
| 43 | — | — | — | 0.034 | 0.022 | — | — | — | 0.0007 | T | T |
| 44 | — | — | — | — | — | — | — | — | — | T | T |
| 45 | — | — | — | — | — | — | — | — | — | T | T |
| 46 | 0.0014 | 0.0021 | 0.041 | — | — | — | — | 0.0008 | 0.0008 | T | T |
| 47 | — | — | — | — | 0.026 | — | — | — | — | T | T |
| 48 | — | 0.0023 | — | 0.039 | — | — | — | — | 0.0005 | T | T |
| 49 | — | — | — | — | — | — | — | — | — | T | T |
| 50 | — | — | — | 0.037 | 0.023 | 0.011 | — | — | — | T | T |
| 51 | — | — | — | 0.028 | 0.027 | — | — | — | — | T | T |
| 52 | — | 0.0027 | — | — | — | — | — | — | 0.0006 | T | T |

Note that, in the column “Formula (1)” in Table 1C, “T” means that the chemical composition satisfies Formula (1), and “F” means that the chemical composition does not satisfy Formula (1). In the column “Formula (2)”, “T” means that the chemical composition satisfies Formula (2), and “F” means that the chemical composition does not satisfy Formula (2).

Slabs (cast pieces) were subjected to hot rolling to produce hot-rolled steel sheets having a thickness of 2.0 mm. The slab heating temperature was 1100 to 1200° C. The rolling finishing temperature was 800 to 1100° C. The coiling temperature was 700 to 800° C. Each hot-rolled steel sheet was subjected to hot-rolled sheet annealing by continuous annealing in which the hot-rolled steel sheet was held at 1000° C. for 60 seconds. Each steel sheet after the hot-rolled sheet annealing was subjected to cold rolling to produce a cold-rolled steel sheet having a thickness of 0.25 mm.

Each produced cold-rolled steel sheet was subjected to final annealing. The maximum attainment temperature T1 (° C.), tension TE (MPa), residence time t0 (secs) and residence time t1 (secs), FA, FB, oxygen potential P_{H20}/P_{H2}, oxygen concentration (%), and temperature gradient CG (° C./m) in the final annealing are shown in Table 2. A non-oriented electrical steel sheet of each test number was produced by the above production process.

TABLE 2

| | Final Annealing Process | | | | | | | | |
|---|---|---|---|---|---|---|---|---|---|
| | Condition 1 | | | | | | | | Condition 5 |
| | Maximum | | Condition 3 | | | | Condition 4 | | Temperature |
| | Attainment | | Residence | Residence | | | | Oxygen | Gradient |
| Test | Temperature | Condition 2 | Time t0 | Time t1 | FA | FB | | Concentration | CG |
| Number | T1 (° C.) | TE(MPa) | (secs) | (secs) | (t1 − t0) | (t1/t0) | P_{H2O}/P_{H2} | (%) | (° C./m) |
| 1 | 820 | 2.5 | 48 | 50 | 2 | 1.0 | 5.12 | 0.001 | 13 |
| 2 | 820 | 2.5 | 17 | 27 | 10 | 1.6 | 0.32 | 0.001 | 15 |
| 3 | 850 | 2.5 | 43 | 51 | 8 | 1.2 | 0.01 | 0.015 | 10 |
| 4 | 820 | 2.5 | 23 | 26 | 3 | 1.1 | 0.13 | 0.001 | 11 |
| 5 | 830 | 2.5 | 27 | 29 | 2 | 1.1 | 0.09 | 0.001 | 12 |
| 6 | 860 | 2.5 | 21 | 24 | 3 | 1.1 | 0.11 | 0.001 | 14 |
| 7 | 850 | 2.5 | 19 | 26 | 7 | 1.4 | 0.13 | 0.001 | 9 |
| 8 | 870 | 2.5 | 23 | 27 | 4 | 1.2 | 0.15 | 0.001 | 10 |
| 9 | 830 | 2.5 | 24 | 27 | 3 | 1.1 | 0.16 | 0.001 | 16 |
| 10 | 810 | 2.5 | 37 | 47 | 10 | 1.3 | 0.30 | 0.001 | 13 |
| 11 | 780 | 7.0 | 32 | 43 | 11 | 1.3 | 0.20 | 0.001 | 11 |
| 12 | 890 | 3.0 | 24 | 29 | 5 | 1.2 | 0.25 | 0.001 | 14 |
| 13 | 890 | 3.0 | 23 | 27 | 4 | 1.2 | 0.16 | 0.001 | 10 |
| 14 | 880 | 3.0 | 25 | 56 | 31 | 2.2 | 0.13 | 0.001 | 11 |
| 15 | 810 | 3.0 | 21 | 28 | 7 | 1.3 | 0.09 | 0.001 | 13 |
| 16 | 800 | 3.0 | 44 | 51 | 7 | 1.2 | 0.24 | 0.001 | 11 |
| 17 | 790 | 3.0 | 27 | 29 | 2 | 1.1 | 0.01 | 0.016 | 11 |
| 18 | 830 | 3.0 | 25 | 27 | 2 | 1.1 | 0.13 | 0.001 | 13 |
| 19 | 850 | 3.0 | 26 | 53 | 27 | 2.0 | 0.20 | 0.001 | 9 |
| 20 | 840 | 3.0 | 22 | 26 | 4 | 1.2 | 0.46 | 0.001 | 10 |
| 21 | 780 | 8.0 | 15 | 29 | 14 | 1.9 | 0.01 | 0.017 | 10 |
| 22 | 920 | 3.0 | 26 | 29 | 3 | 1.1 | 0.16 | 0.001 | 13 |
| 23 | 800 | 2.5 | 18 | 27 | 9 | 1.5 | 0.06 | 0.023 | 11 |
| 24 | 810 | 2.5 | 17 | 28 | 11 | 1.6 | 0.13 | 0.001 | 10 |
| 25 | 830 | 2.5 | 21 | 26 | 5 | 1.2 | 0.25 | 0.001 | 18 |
| 26 | 840 | 2.5 | 18 | 29 | 11 | 1.6 | 0.09 | 0.001 | 13 |
| 27 | 810 | 2.5 | 48 | 53 | 5 | 1.1 | 0.24 | 0.001 | 11 |
| 28 | 910 | 2.5 | 24 | 26 | 2 | 1.1 | 0.17 | 0.001 | 10 |
| 29 | 790 | 2.5 | 27 | 29 | 2 | 1.1 | 0.11 | 0.001 | 11 |
| 30 | 870 | 2.5 | 17 | 27 | 10 | 1.6 | 0.26 | 0.001 | 9 |
| 31 | 830 | 2.5 | 19 | 26 | 7 | 1.4 | 0.36 | 0.001 | 9 |
| 32 | 850 | 3.0 | 23 | 27 | 4 | 1.2 | 0.25 | 0.001 | 11 |
| 33 | 860 | 3.0 | 22 | 26 | 4 | 1.2 | 0.68 | 0.001 | 10 |
| 34 | 820 | 3.0 | 24 | 28 | 4 | 1.2 | 0.82 | 0.001 | 11 |
| 35 | 830 | 3.0 | 23 | 27 | 4 | 1.2 | 0.11 | 0.001 | 10 |
| 36 | 890 | 3.0 | 22 | 26 | 4 | 1.2 | 0.13 | 0.001 | 13 |
| 37 | 860 | 3.0 | 24 | 28 | 4 | 1.2 | 0.25 | 0.001 | 12 |
| 38 | 870 | 3.0 | 13 | 27 | 14 | 2.1 | 0.09 | 0.001 | 13 |
| 39 | 960 | 2.5 | 26 | 27 | 1 | 1.0 | 0.16 | 0.001 | 11 |
| 40 | 970 | 2.5 | 21 | 29 | 8 | 1.4 | 0.20 | 0.001 | 10 |
| 41 | 800 | 1.5 | 24 | 27 | 3 | 1.1 | 0.18 | 0.001 | 9 |
| 42 | 820 | 1.5 | 21 | 29 | 8 | 1.4 | 0.16 | 0.001 | 11 |
| 43 | 780 | 11.0 | 19 | 23 | 4 | 1.2 | 0.24 | 0.001 | 13 |
| 44 | 830 | 11.0 | 23 | 26 | 3 | 1.1 | 0.22 | 0.001 | 12 |
| 45 | 860 | 2.5 | 29 | 18 | −11 | 0.6 | 0.30 | 0.001 | 11 |
| 46 | 830 | 2.5 | 32 | 28 | −4 | 0.9 | 0.24 | 0.001 | 10 |
| 47 | 820 | 2.5 | 26 | 81 | 55 | 3.1 | 0.17 | 0.001 | 9 |
| 48 | 850 | 2.5 | 19 | 61 | 42 | 3.2 | 0.24 | 0.001 | 13 |
| 49 | 820 | 3.0 | 22 | 30 | 8 | 1.4 | 0.00 | 0.001 | 8 |
| 50 | 840 | 3.0 | 17 | 29 | 12 | 1.7 | 0.00 | 0.001 | 10 |
| 51 | 790 | 3.0 | 23 | 34 | 11 | 1.5 | 0.26 | 0.001 | 21 |
| 52 | 810 | 3.0 | 22 | 32 | 10 | 1.5 | 0.36 | 0.001 | 23 |

### [Evaluation Tests]

The non-oriented electrical steel sheet of each test number was subjected to the following evaluation tests.
(Test 1) Chemical composition measurement test
(Test 2) Tensile strength TS measurement test
(Test 3) Work hardening amount WH evaluation test
(Test 4) Test to measure average grain size D
(Test 5) Yield elongation measurement test
(Test 6) Magnetic properties evaluation test
(Test 7) Test to evaluate dimensional accuracy after blanking
Test 1 to test 7 are described hereunder.

### [(Test 1) Chemical Composition Measurement Test]

The chemical composition of the non-oriented electrical steel sheet of each test number was determined according to the method described above in the section [Method for measuring chemical composition of non-oriented electrical steel sheet]. The chemical composition of the non-oriented electrical steel sheet of each test number determined as a result was as shown in Table 1 (Table 1A to Table 1C).

### [(Test 2) Tensile Strength TS Measurement Test]

The tensile strength TS (MPa) of the non-oriented electrical steel sheet of each test number was determined according to the method described above in the section [Stress-strain curve measurement method]. The determined tensile strength TS (MPa) is shown in Table 3.

TABLE 3

| | | | | | | | Magnetic Properties | | | | | |
|---|---|---|---|---|---|---|---|---|---|---|---|---|
| | | | | | | | | Iron Loss | | | | |
| | | Work | | | | | | W_{5/1000} | | Iron Loss | | |
| | Tensile | Hardening | Average | | | | Magnetic | (W/kg) | | Deterioration | | |
| | Strength | Amount | Grain | 80- | | Yield | Flux | | Electrical | Amount | Blanking | |
| Test | TS | WH | Size D | Si × | Formula | Elongation | Density | Shear | Discharge | ΔW_{5/1000} | Flatness | |
| Number | (MPa) | (MPa) | (μm) | 10 | (4) | (%) | B₅₀(T) | Cutting | Machining | (W/kg) | (μm) | Remarks |
| 1 | 613 | 1 | 20 | 47 | T | 2.5 | 1.67 | 16.6 | 16.3 | 0.3 | 12 | Inventive Example |
| 2 | 598 | 0 | 22 | 45 | T | 4.5 | 1.68 | 16.4 | 16.3 | 0.1 | 11 | Inventive Example |
| 3 | 649 | 7 | 27 | 38 | T | 1.0 | 1.67 | 16.2 | 15.0 | 1.2 | 19 | Inventive Example |
| 4 | 605 | 1 | 24 | 44 | T | 2.1 | 1.68 | 16.2 | 15.9 | 0.3 | 12 | Inventive Example |
| 5 | 619 | 2 | 25 | 42 | T | 1.6 | 1.68 | 16.0 | 15.6 | 0.4 | 13 | Inventive Example |
| 6 | 581 | 3 | 29 | 46 | T | 1.5 | 1.68 | 16.0 | 15.4 | 0.6 | 14 | Inventive Example |
| 7 | 651 | 3 | 27 | 41 | T | 1.5 | 1.66 | 15.3 | 14.8 | 0.5 | 16 | Inventive Example |
| 8 | 626 | 5 | 34 | 40 | T | 1.1 | 1.60 | 15.2 | 14.4 | 0.8 | 17 | Inventive Example |
| 9 | 644 | 2 | 23 | 47 | T | 2.1 | 1.65 | 15.7 | 15.3 | 0.4 | 13 | Inventive Example |
| 10 | 618 | 0 | 21 | 45 | T | 2.4 | 1.68 | 16.4 | 16.3 | 0.1 | 11 | Inventive Example |
| 11 | 610 | 0 | 20 | 44 | T | 2.1 | 1.69 | 17.0 | 16.9 | 0.1 | 10 | Inventive Example |
| 12 | 635 | 10 | 37 | 39 | T | 0.7 | 1.66 | 15.6 | 14.1 | 1.5 | 19 | Inventive Example |
| 13 | 664 | 7 | 36 | 37 | T | 1.0 | 1.65 | 15.0 | 13.9 | 1.1 | 18 | Inventive Example |
| 14 | 601 | 9 | 41 | 44 | T | 0.7 | 1.67 | 15.5 | 14.2 | 1.3 | 18 | Inventive Example |
| 15 | 595 | 2 | 21 | 47 | T | 2.1 | 1.68 | 16.9 | 16.4 | 0.5 | 13 | Inventive Example |
| 16 | 616 | 1 | 20 | 45 | T | 2.2 | 1.68 | 16.8 | 16.6 | 0.2 | 13 | Inventive Example |
| 17 | 612 | 0 | 18 | 48 | T | 2.5 | 1.67 | 17.0 | 16.9 | 0.1 | 11 | Inventive Example |
| 18 | 629 | 1 | 22 | 46 | T | 2.1 | 1.66 | 16.0 | 15.8 | 0.2 | 12 | Inventive Example |
| 19 | 622 | 3 | 27 | 42 | T | 1.7 | 1.68 | 15.9 | 15.4 | 0.5 | 14 | Inventive Example |
| 20 | 627 | 2 | 24 | 44 | T | 1.8 | 1.66 | 15.7 | 15.4 | 0.3 | 14 | Inventive Example |
| 21 | 616 | 0 | 18 | 47 | T | 2.8 | 1.67 | 16.9 | 16.8 | 0.1 | 13 | Inventive Example |
| 22 | 591 | 12 | 43 | 45 | T | 0.7 | 1.66 | 15.6 | 13.9 | 1.7 | 16 | Inventive Example |
| 23 | 594 | 1 | 21 | 48 | T | 1.9 | 1.68 | 16.6 | 16.3 | 0.3 | 12 | Inventive Example |
| 24 | 603 | 1 | 22 | 46 | T | 1.9 | 1.68 | 16.5 | 16.2 | 0.3 | 12 | Inventive Example |
| 25 | 606 | 2 | 25 | 44 | T | 1.8 | 1.68 | 16.0 | 15.6 | 0.4 | 14 | Inventive Example |
| 26 | 595 | 3 | 27 | 47 | T | 1.6 | 1.67 | 15.8 | 15.2 | 0.4 | 16 | Inventive Example |
| 27 | 607 | 1 | 23 | 45 | T | 1.9 | 1.68 | 16.3 | 16.0 | 0.3 | 12 | Inventive Example |
| 28 | 607 | 10 | 40 | 42 | T | 0.8 | 1.66 | 15.6 | 14.1 | 1.5 | 16 | Inventive Example |
| 29 | 618 | 1 | 20 | 47 | T | 1.9 | 1.68 | 16.8 | 16.5 | 0.3 | 12 | Inventive Example |
| 30 | 636 | 7 | 33 | 44 | T | 1.5 | 1.65 | 15.0 | 14.0 | 1.0 | 17 | Inventive Example |
| 31 | 604 | 16 | 26 | 48 | T | 0.4 | 1.67 | 17.7 | 15.2 | 2.5 | 29 | Comparative |
| | | | | | | | | | | | | Example |
| 32 | 610 | 17 | 25 | 43 | T | 0.3 | 1.68 | 18.4 | 15.6 | 2.8 | 31 | Comparative |
| | | | | | | | | | | | | Example |
| 33 | 645 | 17 | 28 | 41 | T | 0.3 | 1.66 | 17.2 | 14.7 | 2.5 | 35 | Comparative |
| | | | | | | | | | | | | Example |
| 34 | 654 | 18 | 22 | 42 | T | 0.3 | 1.66 | 18.5 | 15.6 | 2.9 | 40 | Comparative |
| | | | | | | | | | | | | Example |
| 35 | 558 | 17 | 23 | 50 | T | 2.0 | 1.69 | 19.2 | 16.3 | 2.9 | 13 | Comparative |
| | | | | | | | | | | | | Example |
| 36 | 513 | 16 | 34 | 51 | T | 1.5 | 1.70 | 18.4 | 15.8 | 2.6 | 19 | Comparative |
| | | | | | | | | | | | | Example |
| 37 | 595 | 17 | 28 | 50 | T | 1.2 | 1.65 | 17.2 | 14.6 | 2.6 | 31 | Comparative |
| | | | | | | | | | | | | Example |
| 38 | 581 | 16 | 30 | 50 | T | 1.2 | 1.66 | 17.1 | 14.7 | 2.4 | 30 | Comparative |
| | | | | | | | | | | | | Example |
| 39 | 590 | 17 | 67 | 43 | F | 0.1 | 1.65 | 15.3 | 13.0 | 2.3 | 34 | Comparative |
| | | | | | | | | | | | | Example |
| 40 | 611 | 18 | 77 | 41 | F | 0.0 | 1.64 | 15.1 | 12.8 | 2.3 | 28 | Comparative |
| | | | | | | | | | | | | Example |
| 41 | 576 | 13 | 22 | 47 | T | 0.3 | 1.69 | 19.3 | 16.6 | 2.7 | 27 | Comparative |
| | | | | | | | | | | | | Example |
| 42 | 585 | 10 | 25 | 45 | T | 0.4 | 1.69 | 18.8 | 16.0 | 2.8 | 28 | Comparative |
| | | | | | | | | | | | | Example |
| 43 | 579 | 17 | 19 | 47 | T | 1.1 | 1.70 | 20.1 | 17.2 | 2.8 | 33 | Comparative |
| | | | | | | | | | | | | Example |
| 44 | 575 | 17 | 26 | 46 | T | 0.9 | 1.69 | 18.6 | 15.9 | 2.8 | 32 | Comparative |
| | | | | | | | | | | | | Example |
| 45 | 634 | 17 | 28 | 40 | T | 1.0 | 1.67 | 17.7 | 15.1 | 2.6 | 34 | Comparative |
| | | | | | | | | | | | | Example |
| 46 | 601 | 16 | 26 | 44 | T | 1.1 | 1.68 | 18.3 | 15.7 | 2.6 | 36 | Comparative |
| | | | | | | | | | | | | Example |
| 47 | 585 | 16 | 25 | 46 | T | 1.2 | 1.68 | 18.5 | 15.9 | 2.6 | 34 | Comparative |
| | | | | | | | | | | | | Example |
| 48 | 600 | 17 | 30 | 44 | T | 1.1 | 1.67 | 17.6 | 15.0 | 2.6 | 35 | Comparative |
| | | | | | | | | | | | | Example |
| 49 | 598 | 17 | 23 | 46 | T | 1.0 | 1.68 | 18.9 | 16.1 | 2.8 | 28 | Comparative |
| | | | | | | | | | | | | Example |
| 50 | 638 | 17 | 28 | 42 | T | 1.0 | 1.66 | 17.1 | 14.6 | 2.5 | 30 | Comparative |
| | | | | | | | | | | | | Example |
| 51 | 576 | 16 | 21 | 47 | T | 1.2 | 1.69 | 19.7 | 16.9 | 2.8 | 26 | Comparative |
| | | | | | | | | | | | | Example |
| 52 | 598 | 18 | 23 | 45 | T | 1.3 | 1.68 | 19.0 | 16.1 | 3.0 | 30 | Comparative |
| | | | | | | | | | | | | Example |

### [(Test 3) Work Hardening Amount WH Evaluation Test]

The work hardening amount WH (MPa) of the non-oriented electrical steel sheet of each test number was determined according to the method described above in the section [Work hardening amount WH evaluation test]. The determined work hardening amount WH (MPa) is shown in Table 3.

### [(Test 4) Test to Measure Average Grain Size D]

The average grain size D (μm) of the non-oriented electrical steel sheet of each test number was determined according to the method described above in the section [Method for measuring average grain size D]. The determined average grain size D is shown in Table 3.

### [(Test 5) Yield Elongation Measurement Test]

The yield elongation (%) of the non-oriented electrical steel sheet of each test number was determined according to the method described above in the section [Method for measuring yield elongation]. The determined yield elongation (%) is shown in Table 3. Note that, the value of Fn is shown in the column “80-Si×10” in Table 3. Further, in the column “Formula (4)” in Table 3, “T” means that Formula (4) is satisfied, and “F” means that Formula (4) is not satisfied.

### [(Test 6) Magnetic Properties Evaluation Test]

Magnetic flux density B₅₀ (T) and iron loss W_{5/1000} (W/kg) were determined by the following methods.

### [Magnetic Flux Density B₅₀ Evaluation Test]

In the non-oriented electrical steel sheet of each test number, a magnetic flux density B_{50(L)} in the rolling elongation direction (L direction) and a magnetic flux density B_{50(C)} in the direction perpendicular to the rolling elongation direction (C direction) were measured. Specifically, in accordance with JIS C 2550-1: 2011, Epstein test specimens were cut out in the L direction and in the C direction from the non-oriented electrical steel sheet of each test number. The cut-out Epstein test specimens were subjected to a test method for an electrical steel strip and sheet according to JIS C 2550-1: 2011 and 2550-3: 2011, and the magnetic flux densities B_{50(L)} (T) and B_{50(C)} (T) at 5000 A/m in the L direction and the C direction were measured. The arithmetic average value of the magnetic flux density B_{50(L)} (T) in the L direction and the magnetic flux density B_{50(C)} in the C direction was defined as the magnetic flux density B₅₀ (T). The determined magnetic flux density B₅₀ (T) is shown in Table 3.

### [Iron Loss W_{5/1000} Evaluation Test]

Epstein test specimens were prepared in a similar manner to the magnetic flux density B₅₀ evaluation test described above. Note that, the Epstein test specimens were prepared by cutting in two ways: by shear cutting with a clearance set at 20 μm, and by electrical discharge machining. In other words, two types of Epstein test specimens were prepared for each test number: an Epstein test specimen cut out by shear cutting, which intended as blanking; and an Epstein test specimen cut out by electrical discharge machining. Each Epstein test specimen was subjected to a test method for an electrical steel strip and sheet according to JIS C 2550-1: 2011 and 2550-3: 2011, and an iron loss W_{5/1000(L)} (W/kg) and an iron loss W_{5/1000(C)} (W/kg) at 0.5 T at 1000 Hz in the L direction (rolling elongation direction) and the C direction (direction perpendicular to the rolling elongation direction) were measured. The arithmetic average value of the iron loss W_{5/1000(L)} in the L direction (rolling elongation direction) and the iron loss W_{5/1000(C)} (W/kg) in the C direction (direction perpendicular to the rolling elongation direction) was defined as the iron loss W_{5/1000} (W/kg). The iron loss W_{5/1000} (W/kg) in the Epstein test specimen obtained by shear cutting is shown in the column “Shear Cutting” of the column “Iron Loss W_{5/1000} (W/kg)” in Table 3. The iron loss W_{5/1000} (W/kg) in the Epstein test specimen obtained by electrical discharge machining is shown in the column “Electrical Discharge Machining” of the column “Iron Loss W_{5/1000} (W/kg)” in Table 3. A value obtained by subtracting the iron loss W_{5/1000} (W/kg) in the electrical discharge machining from the iron loss W_{5/1000} (W/kg) in the shear cutting was defined as an iron loss deterioration amount ΔW_{5/1000} (W/kg). The iron loss deterioration amount Δ W_{5/1000} (W/kg) is shown in Table 3.

[(Test 7) Test to Evaluate Dimensional Accuracy after Blanking]

The dimensional accuracy after blanking of the non-oriented electrical steel sheet of each test number was evaluated by the following test. A ring-shaped sample (blanked product) having an inner diameter of 90 mm and an outer diameter of 100 mm was prepared by cutting out the ring-shaped sample from the non-oriented electrical steel sheet of each test number using a blanking die in which the clearance was set to 8% of the sheet thickness. Furthermore, the prepared ring-shaped sample was cut at increments of 45° around the normal line of the non-oriented electrical steel sheet from the rolling elongation direction of the non-oriented electrical steel sheet to make eight test specimens. Each test specimen was embedded in resin, and the cut surface was polished to remove 1 mm or more thereof to eliminate the influence of deformation which occurred during cutting. After polishing, the cut surface in the vicinity of the blanked end face on the inner peripheral surface side and the cut surface in the vicinity of the blanked end face on the outer peripheral surface side were observed using an optical microscope with a magnification of 100×. As illustrated in FIG. 6, a line segment 20 connecting a point P1 where the cut surface changed from a shear droop face 10 to a blanked end face 11, and a burr tip P2 of the blanked end face 11 was drawn. A line segment 21 which was parallel to the line segment 20 and was tangent to the blanked end face 11 that protruded from the line segment 20 was drawn. A distance d between the line segment 20 and the line segment 21 was determined. The arithmetic average value of the distances d determined for the eight test specimens (a total of 16 distances d for the inner peripheral surface side and outer peripheral surface side, which consisted of eight distances d on the cut surfaces in the vicinity of the blanked end face on the inner peripheral surface side, and eight distances d on the cut surfaces in the vicinity of the blanked end face on the outer peripheral surface side) was defined as the blanking flatness (μm). The determined blanking flatness is shown in the column “Blanking flatness (μm)” in Table 3.

### [Evaluation Results]

Referring to Table 1 to Table 3, in Test Nos. 1 to 30, feature 1 to feature 5 were satisfied. Therefore, in the non-oriented electrical steel sheets of these test numbers, the magnetic flux density B₅₀ was 1.60 T or more, and the iron loss deterioration amount ΔW_{5/1000} calculated by subtracting the iron loss W_{5/1000} in the shear cutting from the iron loss W_{5/1000} in the electrical discharge machining was 2.0 or less, and thus excellent magnetic properties (magnetic flux density and iron loss) were obtained. In addition, the blanking flatness was 25 μm or less and thus these test numbers were excellent in dimensional accuracy after blanking.

On the other hand, in Test Nos. 31 to 34, Formula (1) or Formula (2) was not satisfied. Therefore, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

In Test Nos. 35 and 36, the content of Si was too low. Therefore, the tensile strength TS was too low. In addition, the work hardening amount WH was 15 MPa or more. As a result, the iron loss deterioration amount ΔW_{5/1000} was more than 2.0, and thus excellent magnetic properties were not obtained.

In Test Nos. 37 and 38, the content of Si was too low. Therefore, the work hardening amount WH was 15 MPa or more. As a result, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

In Test Nos. 39 and 40, condition 1 was not satisfied in the final annealing process. Therefore, the work hardening amount WH was 15 MPa or more. In addition, Formula (4) was not satisfied, and the yield elongation was also less than 0.5%. As a result, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

In Test Nos. 41 and 42, the tension TE at the maximum attainment temperature T1 was too low. Therefore, the yield elongation was less than 0.5%. As a result, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

In Test Nos. 43 and 44, the tension TE at the maximum attainment temperature T1 was too high. Therefore, the work hardening amount WH was 15 MPa or more. As a result, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

In Test Nos. 45 and 46, FA did not satisfy Formula (A) in the final annealing process. Therefore, the work hardening amount WH was 15 MPa or more. As a result, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

In Test Nos. 47 and 48, FB did not satisfy Formula (B). Therefore, the work hardening amount WH was 15 MPa or more. As a result, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

In Test Nos. 49 and 50, condition 4 was not satisfied in the final annealing process. Therefore, the work hardening amount WH was 15 MPa or more. As a result, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

In Test Nos. 51 and 52, the temperature gradient CG was too large. Therefore, the work hardening amount WH was 15 MPa or more. As a result, the blanking flatness was more than 25 μm and sufficient dimensional accuracy was not obtained during blanking. In addition, the iron loss deterioration amount ΔW_{5/1000} was more than 2.0, and thus excellent magnetic properties were not obtained.

### Example 2

Rotor cores having the shape illustrated in FIG. 4 were produced using the non-oriented electrical steel sheets of Test Nos. 1 to 30 of Example 1.

Specifically, the non-oriented electrical steel sheet of each test number was subjected to blanking. In the blanking, a rotor core starting material was prepared by cutting out the non-oriented electrical steel sheet using a blanking die in which the clearance was set to 8% of the sheet thickness. A plurality of the rotor core starting materials were stacked to make the rotor core. The diameter of the rotor core starting material was 70 mm.

The rotor core of each test number was subjected to the following evaluation tests.
(Test 1) Tensile strength TS measurement test
(Test 2) Work hardening amount WH evaluation test
(Test 3) Test to measure average grain size D
(Test 4) Yield elongation measurement test
(Test 5) Magnetic properties evaluation test
(Test 6) Test to evaluate dimensional accuracy after blanking
Test 1 to test 6 are described hereunder.

### [(Test 1) Tensile Strength TS Measurement Test]

The rotor core starting material was separated from the rotor core. The tensile strength TS (MPa) of the rotor core starting material was determined in accordance with the method described above in the section [Method for measuring stress-strain curve of rotor core starting material 2]. Note that, the size of the tensile test specimen taken from the rotor core starting material was as follows: the parallel portion width was 2.50 mm, the gage length was 5.00 mm, the thickness was 0.25 mm, and the overall length was 25 mm. The tensile strength TS (MPa) of the rotor core starting material is shown in Table 4.

### [(Test 2) Work Hardening Amount WH Evaluation Test]

The work hardening amount WH of the rotor core starting material was determined in accordance with the method described above in the section [Test to evaluate work hardening amount WH of rotor core starting material 2]. The determined work hardening amount WH (MPa) of the rotor core starting material is shown in Table 4.

### [(Test 3) Test to Measure Average Grain Size D]

The rotor core starting material was separated from the rotor core. The average grain size D (μm) of the rotor core starting material was determined in accordance with the method described above in the section [Method for measuring average grain size D of rotor core starting material 2]. The determined average grain size D (μm) of the rotor core starting material is shown in Table 4.

### [(Test 4) Yield Elongation Measurement Test]

The rotor core starting material was separated from the rotor core. The yield elongation (%) of the rotor core starting material was determined in accordance with the method described above in the section [Method for measuring yield elongation of rotor core starting material 2]. Note that, the size of the tensile test specimen taken from the rotor core starting material was as follows: the parallel portion width was 2.50 mm, the gage length was 5.00 mm, the thickness was 0.25 mm, and the overall length was 25 mm. The yield elongation (%) of the rotor core starting material is shown in Table 4.

### [(Test 5) Magnetic Properties Evaluation Test]

The rotor core starting material was separated from the rotor core. A small test specimen for single-sheet magnetic measurement with dimensions that allowed the small test specimen to be taken was prepared by electrical discharge machining from the separated rotor core starting material. The size of the small test specimen was 10 mm×20 mm×the sheet thickness.

The magnetic flux density B₅₀ (T) and the iron loss W_{5/1000} (W/kg) of the rotor core starting material were determined using the small test specimen and a single sheet tester in accordance with the single sheet magnetic property test method (single sheet tester: SST) prescribed in JIS C 2556: 2015.

The determined magnetic flux density B₅₀ (T) and iron loss W_{5/1000} (W/kg) of the rotor core starting material are shown in Table 4.

[(Test 6) Test to Evaluate Dimensional Accuracy after Blanking]

The rotor core starting material obtained after blanking was cut at increments of 45° around the central axis of the rotor core starting material to make eight test specimens which included the outer peripheral surface side of the rotor core starting material at the time blanking was performed. Each test specimen was embedded in resin, and the cut surface was polished to remove 1 mm or more thereof to eliminate the influence of deformation that occurred during cutting. After polishing, the cut surface of a portion in the vicinity of the outer peripheral surface of the rotor core starting material was observed using an optical microscope with a magnification of 100×. As illustrated in FIG. 6, a line segment 20 connecting a point P1 where the cut surface changed from a shear droop face 10 to a blanked end face 11, and a burr tip P2 of the blanked end face 11 was drawn. A line segment 21 which was parallel to the line segment 20 and was tangent to the blanked end face 11 that protruded from the line segment 20 was drawn. A distance d between the line segment 20 and the line segment 21 was determined. The arithmetic average value of the distances d (a total of eight distances d) determined in the eight test specimens was defined as the blanking flatness (μm). The determined blanking flatness (μm) of the rotor core starting material is shown in Table 4. Note that, with regard to the inner peripheral surface side of the rotor core starting material, in some cases the blanked end face when blanking is performed may not be maintained due to processing performed when inserting a shaft or the like. Therefore, as mentioned above, the dimensional accuracy at the blanked end face of a portion in the vicinity of the outer peripheral surface of the rotor core starting material was evaluated.

TABLE 4

| | | Work | | | | | Magnetic Properties | | | |
|---|---|---|---|---|---|---|---|---|---|---|
| | Tensile | Hardening | Average | | | | Magnetic | | | |
| | Strength | Amount | Grain | 80- | | Yield | Flux | Iron Loss | Blanking | |
| Test | TS | WH | Size D | Si × | Formula | Elongation | Density | W_{5/1000} | Flatness | |
| Number | (MPa) | (MPa) | (μm) | 10 | (4) | (%) | B₅₀(T) | (W/kg) | (μm) | Remarks |
| 1 | 610 | 1 | 19 | 47 | T | 2.2 | 1.66 | 16.5 | 11 | Inventive |
| | | | | | | | | | | Example |
| 2 | 591 | 0 | 22 | 45 | T | 4.3 | 1.67 | 16.5 | 12 | Inventive |
| | | | | | | | | | | Example |
| 3 | 640 | 6 | 27 | 38 | T | 1.0 | 1.66 | 15.4 | 18 | Inventive |
| | | | | | | | | | | Example |
| 4 | 600 | 2 | 25 | 44 | T | 1.9 | 1.68 | 16.1 | 13 | Inventive |
| | | | | | | | | | | Example |
| 5 | 615 | 2 | 25 | 42 | T | 1.5 | 1.67 | 15.7 | 12 | Inventive |
| | | | | | | | | | | Example |
| 6 | 573 | 2 | 28 | 46 | T | 1.3 | 1.68 | 15.6 | 12 | Inventive |
| | | | | | | | | | | Example |
| 7 | 645 | 3 | 27 | 41 | T | 1.5 | 1.65 | 15.0 | 15 | Inventive |
| | | | | | | | | | | Example |
| 8 | 620 | 4 | 32 | 40 | T | 1.1 | 1.60 | 14.6 | 18 | Inventive |
| | | | | | | | | | | Example |
| 9 | 640 | 2 | 25 | 47 | T | 2.0 | 1.64 | 15.6 | 13 | Inventive |
| | | | | | | | | | | Example |
| 10 | 610 | 1 | 21 | 45 | T | 2.2 | 1.67 | 16.4 | 11 | Inventive |
| | | | | | | | | | | Example |
| 11 | 603 | 0 | 20 | 44 | T | 2.2 | 1.68 | 16.9 | 11 | Inventive |
| | | | | | | | | | | Example |
| 12 | 622 | 9 | 36 | 39 | T | 0.6 | 1.65 | 14.5 | 18 | Inventive |
| | | | | | | | | | | Example |
| 13 | 650 | 6 | 36 | 37 | T | 1.0 | 1.65 | 14.2 | 19 | Inventive |
| | | | | | | | | | | Example |
| 14 | 591 | 8 | 41 | 44 | T | 0.7 | 1.66 | 14.5 | 18 | Inventive |
| | | | | | | | | | | Example |
| 15 | 590 | 2 | 20 | 47 | T | 2.0 | 1.67 | 16.7 | 13 | Inventive |
| | | | | | | | | | | Example |
| 16 | 610 | 2 | 20 | 45 | T | 2.1 | 1.67 | 16.7 | 12 | Inventive |
| | | | | | | | | | | Example |
| 17 | 603 | 1 | 19 | 48 | T | 2.4 | 1.67 | 16.9 | 10 | Inventive |
| | | | | | | | | | | Example |
| 18 | 615 | 2 | 22 | 46 | T | 2.0 | 1.65 | 15.8 | 12 | Inventive |
| | | | | | | | | | | Example |
| 19 | 613 | 4 | 26 | 42 | T | 1.7 | 1.67 | 15.5 | 13 | Inventive |
| | | | | | | | | | | Example |
| 20 | 615 | 2 | 25 | 44 | T | 1.8 | 1.66 | 15.6 | 12 | Inventive |
| | | | | | | | | | | Example |
| 21 | 610 | 1 | 19 | 47 | T | 2.6 | 1.67 | 16.8 | 15 | Inventive |
| | | | | | | | | | | Example |
| 22 | 580 | 11 | 42 | 45 | T | 0.7 | 1.65 | 14.3 | 16 | Inventive |
| | | | | | | | | | | Example |
| 23 | 580 | 2 | 20 | 48 | T | 1.7 | 1.67 | 16.4 | 12 | Inventive |
| | | | | | | | | | | Example |
| 24 | 691 | 1 | 21 | 46 | T | 1.8 | 1.67 | 16.2 | 11 | Inventive |
| | | | | | | | | | | Example |
| 25 | 600 | 1 | 26 | 44 | T | 1.7 | 1.67 | 15.8 | 14 | Inventive |
| | | | | | | | | | | Example |
| 26 | 590 | 2 | 26 | 47 | T | 1.6 | 1.67 | 15.4 | 15 | Inventive |
| | | | | | | | | | | Example |
| 27 | 600 | 2 | 24 | 45 | T | 1.8 | 1.67 | 16.2 | 11 | Inventive |
| | | | | | | | | | | Example |
| 28 | 597 | 8 | 39 | 42 | T | 0.9 | 1.65 | 14.8 | 16 | Inventive |
| | | | | | | | | | | Example |
| 29 | 610 | 2 | 20 | 47 | T | 1.8 | 1.67 | 16.6 | 12 | Inventive |
| | | | | | | | | | | Example |
| 30 | 621 | 6 | 33 | 44 | T | 1.5 | 1.64 | 14.3 | 16 | Inventive |
| | | | | | | | | | | Example |

### [Evaluation Results]

As shown in Table 4, with respect to the rotor core, in the rotor core starting materials of Test Nos. 1 to 30, feature 1 to feature 5 were satisfied. Therefore, in the rotor core starting materials of these test numbers, the blanking flatness was 25 μm or less, and thus these rotor core starting materials were excellent in dimensional accuracy after blanking. Note that, in the rotor core starting materials, the magnetic flux density B₅₀ was 1.60 T or more and the iron loss W_{5/1000} was 16.9 W/kg or less, and thus high strength and excellent magnetic properties were obtained.

Whilst a preferred embodiment of the non-oriented electrical steel sheet of the present disclosure has been described above, the non-oriented electrical steel sheet of the present disclosure is not limited to the above example. It is clear that those skilled in the art will be able to contrive various examples of changes and modifications within the category of the technical idea described in the appended claims, and it should be understood that they also naturally belong to the technical scope of the non-oriented electrical steel sheet of the present disclosure.

1.-6. (canceled)

7. A non-oriented electrical steel sheet consisting of, in mass %,
Si: 3.1 to 4.5%,
C: 0.0025% or less,
N: 0.0025% or less,
O: 0.0400% or less,
P: 0.100% or less,
S: 0.0050% or less,
Ti: 0.0100% or less,
Mn: 2.0% or less,
Al: 1.500% or less,
Zr: 0 to 0.0100%,
Nb: 0 to 0.0100%,
V: 0 to 0.0100%,
Mo: 0 to 0.100%,
Cr: 0 to 2.000%,
La: 0 to 0.0100%,
Ce: 0 to 0.0100%,
B: 0 to 0.0010%,
Zn: 0 to 0.0050%,
Ga: 0 to 0.0050%,
Ge: 0 to 0.0050%,
As: 0 to 0.0100%,
Ni: 0 to 0.500%,
Cu: 0 to 0.500%,
Sn: 0 to 0.200%,
Sb: 0 to 0.100%,
Ca: 0 to 0.0050%,
Nd: 0 to 0.0010%, and
Mg: 0 to 0.0030%,
with the balance being Fe and impurities, and satisfying Formula (1) and Formula (2),
wherein:
a tensile strength TS is higher than 570 MPa;
when a stress at 2.0% strain is expressed as Y_{2.0} (MPa) and a yield stress is expressed as YS (MPa), a work hardening amount WH defined by Formula (3) is less than 15 MPa; and
an average grain size D (m) satisfies Formula (4), and a yield elongation is 0.5% or more;
$$Si / 28 + Ti / 48 + Nb / 93 + V / 51 + Zr / 91 + Mo / 96 + Cr / 52 > C / 12 \times 750 \qquad ( 1 )$$
$$Si / 28 + Al / 27 + Ti / 48 + Zr / 91 + La / 139 + Ce / 140 > N / 14 \times 1000 \qquad ( 2 )$$
$$WH = {Y}_{2.} ‐ YS \qquad ( 3 )$$
$$D < 80 ‐ Si \times 10 \qquad ( 4 )$$
where, a content of a corresponding element in percent by mass is substituted for each symbol of an element in Formula (1), Formula (2) and Formula (4), and if a corresponding element is not contained, “0” is substituted for the symbol of the corresponding element.

8. The non-oriented electrical steel sheet according to claim 7, comprising one or more types of element selected from a group consisting of, in mass %,
Zr: 0.0001 to 0.0100%,
Nb: 0.0001 to 0.0100%,
V: 0.0001 to 0.0100%,
Mo: 0.001 to 0.100%,
Cr: 0.001 to 2.000%,
La: 0.0001 to 0.0100%,
Ce: 0.0001 to 0.0100%,
B: 0.0001 to 0.0010%,
Zn: 0.0001 to 0.0050%,
Ga: 0.0001 to 0.0050%,
Ge: 0.0001 to 0.0050%,
As: 0.0001 to 0.0100%,
Ni: 0.001 to 0.500%,
Cu: 0.001 to 0.500%,
Sn: 0.001 to 0.200%,
Sb: 0.001 to 0.100%,
Ca: 0.0001 to 0.0050%,
Nd: 0.0001 to 0.0010%, and
Mg: 0.0001 to 0.0030%.

9. A rotor core, comprising a plurality of rotor core starting materials stacked together,
the rotor core starting material consisting of, in mass %,
Si: 3.1 to 4.5%,
C: 0.0025% or less,
N: 0.0025% or less,
O: 0.0400% or less,
P: 0.100% or less,
S: 0.0050% or less,
Ti: 0.0100% or less,
Mn: 2.0% or less,
Al: 1.500% or less,
Zr: 0 to 0.0100%,
Nb: 0 to 0.0100%,
V: 0 to 0.0100%,
Mo: 0 to 0.100%,
Cr: 0 to 2.000%,
La: 0 to 0.0100%,
Ce: 0 to 0.0100%,
B: 0 to 0.0010%,
Zn: 0 to 0.0050%,
Ga: 0 to 0.0050%,
Ge: 0 to 0.0050%,
As: 0 to 0.0100%,
Ni: 0 to 0.500%,
Cu: 0 to 0.500%,
Sn: 0 to 0.200%,
Sb: 0 to 0.100%,
Ca: 0 to 0.0050%,
Nd: 0 to 0.0010%, and
Mg: 0 to 0.0030%,
with the balance being Fe and impurities, and satisfying Formula (1) and Formula (2),
wherein:
a tensile strength TS is higher than 570 MPa;
when a stress at 2.0% strain is expressed as Y_{2.0} (MPa) and a yield stress is expressed as YS (MPa), a work hardening amount WH defined by Formula (3) is less than 15 MPa; and
an average grain size D (m) satisfies Formula (4), and a yield elongation is 0.5% or more;
$$Si / 28 + Ti / 48 + Nb / 93 + V / 51 + Zr / 91 + Mo / 96 + Cr / 52 > C / 12 \times 750 \qquad ( 1 )$$
$$Si / 28 + Al / 27 + Ti / 48 + Zr / 91 + La / 139 + Ce / 140 > N / 14 \times 1000 \qquad ( 2 )$$
$$WH = {Y}_{2.} ‐ YS \qquad ( 3 )$$
$$D < 80 ‐ Si \times 10 \qquad ( 4 )$$
where, a content of a corresponding element in percent by mass is substituted for each symbol of an element in Formula (1), Formula (2) and Formula (4), and if a corresponding element is not contained, “0” is substituted for the symbol of the corresponding element.

10. The rotor core according to claim 9, wherein the rotor core starting material comprises one or more types of element selected from a group consisting of, in mass %,
Zr: 0.0001 to 0.0100%,
Nb: 0.0001 to 0.0100%,
V: 0.0001 to 0.0100%,
Mo: 0.001 to 0.100%,
Cr: 0.001 to 2.000%,
La: 0.0001 to 0.0100%,
Ce: 0.0001 to 0.0100%,
B: 0.0001 to 0.0010%,
Zn: 0.0001 to 0.0050%,
Ga: 0.0001 to 0.0050%,
Ge: 0.0001 to 0.0050%,
As: 0.0001 to 0.0100%,
Ni: 0.001 to 0.500%,
Cu: 0.001 to 0.500%,
Sn: 0.001 to 0.200%,
Sb: 0.001 to 0.100%,
Ca: 0.0001 to 0.0050%,
Nd: 0.0001 to 0.0010%, and
Mg: 0.0001 to 0.0030%.

11. A motor comprising the rotor core according to claim 9.

12. A motor comprising the rotor core according to claim 10.

13. A method for producing the non-oriented electrical steel sheet according to claim 7, comprising:
a hot rolling process of subjecting a slab to hot rolling to produce a hot-rolled steel sheet,
a cold rolling process of subjecting the hot-rolled steel sheet to cold rolling to produce a cold-rolled steel sheet, and
a final annealing process of subjecting the cold-rolled steel sheet to final annealing in a final annealing furnace,
wherein, in the final annealing process:
the cold-rolled steel sheet is annealed at a maximum attainment temperature T1 of 950° C. or less,
a tension TE applied to the cold-rolled steel sheet at the maximum attainment temperature T1 is set to 2.0 to 10.0 MPa,
a residence time t0 (seconds) from an annealing temperature T1 to 700° C. in a heating zone, a soaking zone, and a cooling zone of the final annealing furnace, and a residence time t1 (seconds) from 700 to 500° C. in the cooling zone are set to satisfy Formula (A) and Formula (B),
at one location or more selected from the heating zone, the soaking zone, and the cooling zone in a temperature range of 500° C. or more in a furnace atmosphere of the final annealing furnace, a ratio of a water vapor partial pressure P_{H20} (atm) to a hydrogen partial pressure P_{H2} (atm) is made higher than 0.05, or an oxygen concentration is made higher than 0.010%, and
a temperature gradient CG in a longitudinal direction of the cold-rolled steel sheet in a cooling process is made 20° C./m or less,
$$t 1 ‐ t 0 > 0 \qquad ( A )$$
$$t 1 / t 0 \leq 3. . \qquad ( B )$$
